(19) United States
(12) Patent Application Publication
(10) Pub. No.: US 2021/0292243 A1
(43) Pub. Date: Sep. 23, 2021

(54) ADDITIVE MANUFACTURING METHOD FOR MAKING NON-OXIDE CERAMIC ARTICLES, AND AEROGELS, XEROGELS, AND POROUS CERAMIC ARTICLES

(71) Applicant: 3M INNOVATIVE PROPERTIES COMPANY, St. Paul, MN (US)

(72) Inventors: Gareth A. Hughes, St. Paul, MN (US); Melissa A. Lackey, Woodbury, MN (US); Brant U. Kolb, Stillwater, MN (US); Jerome G. Magnant, Woodbury, MN (US); Zeba Parkar, Marietta, GA (US); Kevin M. Casey, Woodbury, MN (US); Nicholas S. Wren, Woodbury, MN (US)

(21) Appl. No.: 17/260,344

(22) PCT Filed: Aug. 22, 2019
(86) PCT No.: PCT/US2019/047604

§ 371 Date: Jan. 14, 2021

Related U.S. Application Data
(60) Provisional application No. 62/725,793, filed on Aug. 31, 2018.

(51) Int. Cl. C04B 35/584; C04B 35/634; C04B 35/624; C04B 35/626; C04B 35/64; C04B 38/06; B29C 64/124; B33Y 10/00; B33Y 70/10; B28B 1/00

(52) U.S. Cl. CPC C04B 35/584; B29K 2509/04; C04B 35/624; C04B 35/62655; C04B 35/64; C04B 38/067; B29C 64/124; B33Y 10/00; B33Y 70/10; B28B 1/001; C04B 2235/3873; C04B 2235/3217; C04B 2235/3225; C04B 2235/606; C04B 2235/6026; C04B 2235/77; C04B 35/63424

(57) ABSTRACT

The present disclosure provides a method of making a non-oxide ceramic part. The method includes obtaining a photopolymerizable slurry; selectively curing the photopolymerizable slurry to obtain a gelled article; drying the gelled article to form an aerogel article or a xerogel article; heat treating the aerogel article or the xerogel article to form a porous ceramic article; and sintering the porous ceramic article to obtain a sintered ceramic article. The photopolymerizable slurry includes non-oxide ceramic particles; at least one radiation curable monomer; a solvent; a photoinitiator; an inhibitor; and at least one sintering aid. Further, aerogels, xerogels, porous ceramic articles, and non-oxide ceramic articles are provided. In addition, methods are provided, including receiving, by a manufacturing device having one or more processors, a digital object comprising data specifying an article; and generating, with the manufacturing device by an additive manufacturing process, the article based on the digital object. A system is also provided, including a display that displays a 3D model of an article; and one or more processors that, in response to the 3D model selected by a user, cause a 3D printer to create a physical object of an article.

### TECHNICAL FIELD

The present disclosure broadly relates to an additive manufacturing method for producing ceramic articles using a slurry containing non-oxide particles as a construction material. The invention also relates to articles obtainable by such a method.

### BACKGROUND

In conventional ceramic processing, e.g. slip casting, the ceramic slurries usually have to have a particle load as high as possible to obtain an intermediate body with a high green density. A high green density is desired and needed to enable the production of dense sintered ceramics. Powder-based additive manufacturing technologies where the low packing density of the powder bed results in a highly porous 3D object, typically does not result in a high density ceramic without the addition of large amounts of pressure during heat treatment, making the realization of dense complex three dimension shapes challenging. Typically this method leads to densities of less than 95% of the theoretical density of the ceramic material.

The processing of slurries based on ceramic filled photopolymers with stereolithography has shown promise due to its ability to serve as a green body in the production of relatively dense ceramic articles with three dimensional architecture. Meanwhile, there are efforts trying to also use additive manufacturing technologies (like stereolithography), which are mainly used for processing polymers, for the production of ceramic articles. For instance, WO 2016/191162 (Mayr et al.) describes an additive manufacturing process for producing ceramic articles using a sol containing nano-sized particles.

### SUMMARY

In a first aspect, a method of making a non-oxide ceramic part is provided. The method includes a) obtaining a photopolymerizable slurry; b) selectively curing the photopolymerizable slurry to obtain a gelled article; c) drying the gelled article to form an aerogel article or a xerogel article; d) heat treating the aerogel article or the xerogel article to form a porous ceramic article; and e) sintering the porous ceramic article to obtain a sintered ceramic article. The photopolymerizable slurry includes non-oxide ceramic particles; at least one radiation curable monomer; a solvent; a photoinitiator; an inhibitor; and at least one sintering aid.

In a second aspect, an aerogel is provided. The aerogel includes a) an organic material; b) non-oxide ceramic particles in a range of 29 to 75 weight percent, based on the total weight percent of the aerogel; and c) at least one sintering aid.

In a third aspect, a xerogel is provided. The xerogel includes a) an organic material; b) non-oxide ceramic particles in a range of 29 to 75 weight percent, based on the total weight percent of the xerogel; and c) at least one sintering aid.

In a fourth aspect, a porous ceramic article is provided. The porous ceramic article includes a) non-oxide ceramic particles in a range of 90 to 99 weight percent, based on the total weight of the porous ceramic article; and b) at least one sintering aid. The non-oxide ceramic particles define one or more tortuous or arcuate channels, one or more internal architectural voids, one or more undercuts, one or more perforations, or combinations thereof in the porous ceramic article. The porous ceramic article includes at least one feature integral to the porous ceramic article having a dimension of 0.5 mm length or less.

In a fifth aspect, a non-oxide ceramic article is provided. The non-oxide ceramic material defines one or more tortuous or arcuate channels, one or more internal architectural voids, one or more undercuts, one or more perforations, or combinations thereof in the non-oxide ceramic article. The non-oxide ceramic article exhibits a density of 95% or greater with respect to a theoretical density of the non-oxide ceramic material. The non-oxide ceramic article includes at least one feature integral to the non-oxide ceramic article having a dimension of 0.5 mm length or less.

In a sixth aspect, another method is provided. The method includes a) retrieving, from a non-transitory machine readable medium, data representing a 3D model of an article; b) executing, by one or more processors, a 3D printing application interfacing with a manufacturing device using the data; and c) generating, by the manufacturing device, a physical object of the article, the article comprising a gelled article obtained by selectively curing a photopolymerizable slurry. The photopolymerizable slurry includes non-oxide ceramic particles; at least one radiation curable monomer; a solvent; a photoinitiator; an inhibitor; and at least one sintering aid.

In a seventh aspect, a further method is provided. The method includes a) receiving, by a manufacturing device having one or more processors, a digital object comprising data specifying a plurality of layers of an article; and b) generating, with the manufacturing device by an additive manufacturing process, the article based on the digital object, the article comprising a gelled article obtained by selectively curing a photopolymerizable slurry. The photopolymerizable slurry includes non-oxide ceramic particles; at least one radiation curable monomer; a solvent; a photoinitiator; an inhibitor; and at least one sintering aid.

In an eighth aspect, a system is provided. The system includes a display that displays a 3D model of an article; and one or more processors that, in response to the 3D model selected by a user, cause a 3D printer to create a physical object of an article, the article comprising a gelled article obtained by selectively curing a photopolymerizable slurry. The photopolymerizable slurry includes non-oxide ceramic particles; at least one radiation curable monomer; a solvent; a photoinitiator; an inhibitor; and at least one sintering aid.

In a ninth aspect, a non-transitory machine readable medium is provided. The non-transitory machine readable medium includes data representing a three-dimensional model of an article, when accessed by one or more processors interfacing with a 3D printer, causes the 3D printer to create an article comprising a reaction product of a photopolymerizable slurry. The photopolymerizable slurry includes non-oxide ceramic particles; at least one radiation curable monomer; a solvent; a photoinitiator; an inhibitor; and at least one sintering aid.

Ceramic parts made according to at least certain embodiments of this disclosure were found to exhibit acceptable density despite the low particle loadings of the photopolymerizable compositions.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 is a flowchart of a process for building an article using the photopolymerizable compositions disclosed herein.

FIG. 2 is a generalized schematic of a stereolithography apparatus.

FIG. 3A is a perspective view of a gelled article, prepared according to one embodiment of the present disclosure.

FIG. 3B is a perspective view of an aerogel article formed from the gelled article of FIG. 3A,

FIG. 3C is a perspective view of a porous ceramic article formed from the aerogel article of FIG. 3B

FIG. 3D is a perspective view of a sintered ceramic article formed from the porous ceramic article of FIG. 3C.

FIG. 4A is a perspective view of an aerogel article of Comparative Example 1.

FIG. 4B is a perspective view of shards of a sintered ceramic article of FIG. 4A formed from the aerogel article of FIG. 4A.

FIG. 5 is a generalized schematic of an apparatus in which radiation is directed through a container.

FIG. 6 is a block diagram of a generalized system 600 for additive manufacturing of an article.

FIG. 7 is a block diagram of a generalized manufacturing process for an article.

FIG. 8 is a high-level flow chart of an exemplary article manufacturing process.

FIG. 9 is a high-level flow chart of an exemplary article additive manufacturing process.

FIG. 10 is a schematic front view of an exemplary computing device 1000.

FIG. 11A is a perspective view of a gelled article of Example 3.

FIG. 11B is a perspective view of a sintered article formed from the gelled article of FIG. 11A.

FIG. 12A is a perspective view of a gelled article of Comparative Example 5.

FIG. 12B is a perspective view of an aerogel article formed from the gelled article of FIG. 12A.

FIG. 13A is a perspective view of a gelled article of Example 6.

FIG. 13B is a perspective view of an aerogel article formed from the gelled article of FIG. 13A.

FIG. 13C is a perspective view of a sintered ceramic article formed from the aerogel article of FIG. 13B.

While the above-identified figures set forth several embodiments of the disclosure other embodiments are also contemplated, as noted in the description. The figures are not necessarily drawn to scale. In all cases, this disclosure presents the invention by way of representation and not limitation. It should be understood that numerous other modifications and embodiments can be devised by those skilled in the art, which fall within the scope and spirit of the principles of the invention.

### DETAILED DESCRIPTION OF ILLUSTRATIVE EMBODIMENTS

The present disclosure provides a method to produce non-oxide ceramic parts using additive manufacturing from a particle loaded slurry that would generally be highly light scattering, and UV photocuring the slurry using additive manufacturing techniques. Such techniques allow for parts with complex geometries and fine features unavailable using traditional non-oxide ceramic manufacturing processes such as hot pressing or machining, and should additionally reduce the processing equipment overhead for similarly sized parts. Non-oxide ceramic particles are typically challenging to fabricate economically in nanoparticle sizes, hence slurries are usually made with particles in the submicron to micron range. Such slurries are typically opaque to light due to high scattering from the particles. This means such slurries are generally incompatible with light curing techniques, which most slurry-based additive manufacturing techniques require.

The low loading of non-oxide particles according to at least certain embodiments of the disclosure enables lower composition viscosities and deeper cure depths during photopolymerization in an additive manufacturing method (e.g., stereolithography), yet unexpectedly can produce a ceramic part after post-processing steps. For instance, the cure depth of slurries containing non-oxide particles was analyzed using a photomask of a 4 mm diameter circle and timing the exposure of light on an Asiga Pico 2 3D printer (Asiga USA, Anaheim Hills, Calif.), and showed reasonable cure depth at cure times of under ten seconds. At longer time scales, however, light scattering created extensive overcure, as lighter regions around the cured circles. The relationship between cure depth and overcure is important; as the exposure required to get a suitable cure depth from printing increases, the amount of overcure increases. Keeping overcure to a minimum is required to achieve accurately printed parts because overcure causes parts to have flaking edges and can contribute to failed prints.

### Glossary

As used herein, “ceramic” or “ceramic article” means a non-metallic material that is produced by application of heat. Ceramics are usually hard, and brittle and, in contrast to glasses or glass-ceramics, display an essentially purely crystalline structure. Ceramics are usually classified as inorganic materials. “Crystalline” means a solid composed of atoms arranged in a pattern periodic in three dimensions (i.e., has long-range crystal structure which may be determined by techniques such as X-ray diffraction). A “crystallite” means a crystalline domain of a solid having a defined crystal structure. A crystallite can only have one crystal phase.

As used herein, “additive manufacturing” means processes used to make 3-dimensional articles. An example of an additive manufacturing technique is stereolithography (SLA), in which successive layers of material are laid down under computer control. The articles can be of almost any shape or geometry and are produced from a 3-dimensional model or other electronic data source.

As used herein, “slurry” refers to a continuous liquid phase containing discrete particles having sizes in a range from 1 nanometer (nm) to 50 micrometers or from 1 nm to 10 micrometers. Typically, a majority (i.e., more than 50%) of the particles have a diameter of 100 nm or greater.

As used herein, “machining” refers to milling, grinding, cutting, carving, or shaping a material by a machine. Milling is usually faster and more cost effective than grinding A “machinable article” is an article having a 3-dimensional shape and having sufficient strength to be machined.

As used herein, a “powder” refers to a dry, bulk material composed of a large number of fine particles that may flow freely when shaken or tilted.

As used herein, a “particle” refers to a substance being a solid having a shape which can be geometrically determined. The shape can be regular or irregular. Particles can typically be analyzed with respect to e.g., particle size and particle size distribution. A particle can comprise one or more crystallites. Thus, a particle can comprise one or more crystal phases.

As used herein, “associated” refers to a grouping of two or more primary particles that are aggregated and/or agglomerated. Similarly, the term “non-associated” refers to two or more primary particles that are free or substantially free from aggregation and/or agglomeration.

As used herein, “aggregation” refers to a strong association of two or more primary particles. For example, the primary particles may be chemically bound to one another. The breakdown of aggregates into smaller particles (e.g., primary particles) is generally difficult to achieve.

As used herein, “agglomeration” refers to a weak association of two or more primary particles. For example, particles may be held together by charge or polarity. The breakdown of agglomerates into smaller particles (e.g., primary particles) is less difficult than the breakdown of aggregates into smaller particles.

As used herein, “primary particle size” refers to the size of a non-associated single crystal non-oxide ceramic particle, which is considered to be a primary particle. X-ray diffraction (XRD) is typically used to measure the primary particle size.

As used herein, “soluble” means that a component (e.g., a solid) can be completely dissolved within a solvent. That is, the substance is able to form individual molecules (like glucose), ions (like sodium chloride), or non-settling particles (like a slurry) when dispersed in water at 23° C. The solubilization process, however, might take some time, e.g. stirring the component over a couple of hours (e.g., 10 to 20 hours) might be required.

As used herein, “density” means the ratio of mass to volume of an object. The unit of density is typically grams per cubic centimeter (g/cm³). The density of an object can be calculated e.g., by determining its volume (e.g., by calculation or applying the Archimedes principle or method) and measuring its mass. The volume of a sample can be determined based on the overall outer dimensions of the sample. The density of the sample can be calculated from the measured sample volume and the sample mass. The total volume of a material sample can be calculated from the mass of the sample and the density of the used material. The total volume of cells in the sample is assumed to be the remainder of the sample volume (100% minus the total volume of material).

As used herein, “theoretical density” refers to the maximum possible density that would be obtained in a sintered article if all pores were removed. The percent of the theoretical density for a sintered article can be determined, for example, from electron micrographs of a cross-section of the sintered article. The percent of the area of the sintered article in the electron micrograph that is attributable to pores can be calculated. Stated differently, the percent of the theoretical density can be calculated by subtracting the percent voids from 100 percent. That is, if 1 percent of the area of the electron micrograph of the sintered article is attributable to pores, the sintered article is considered to have a density equal to 99 percent of the theoretical density. The density can also be determined by the Archimedes method.

As used herein, “porous material” refers to a material comprising a partial volume that is formed by voids, pores, or cells in the technical field of ceramics. Accordingly, an “open-celled” structure of a material sometimes is referred to as “open-porous” structure, and a “closed-celled” material structure sometimes is referred to as a “closed-porous” structure. It may also be found that instead of the term “cell” sometimes “pore” is used in this technical field. The material structure categories “open-celled” and “closed-celled” can be determined for different porosities measured on different material samples (e.g., using a mercury “Poremaster 60-GT” from Quantachrome Inc., USA) according to DIN 66133. A material having an open-celled or open-porous structure can be passed through by e.g., gases.

As used herein, “heat treating” or “debindering” refers to a process of heating solid material to drive off at least 90 percent by weight of volatile chemically bond components (e.g., organic components) (versus, for example, drying, in which physically bonded water is driven off by heating). Heat treating is done at a temperature below a temperature needed to conduct a sintering step.

As used herein, “sintering” and “firing” are used interchangeably. A porous (e.g., pre-sintered) ceramic article shrinks during a sintering step, that is, if an adequate temperature is applied. The sintering temperature to be applied depends on the ceramic material chosen. Sintering typically includes the densification of a porous material to a less porous material (or a material having less cells) having a higher density, in some cases sintering may also include changes of the material phase composition (for example, a partial conversion of an amorphous phase toward a crystalline phase).

As used herein, “green body gel”, “gelled article”, and “gelled body” are used interchangeably and mean a three-dimensional gel resulting from the curing reaction of polymerizable components contained in a slurry, including organic binder and solvent.

As used herein, “aerogel” means a three-dimensional low-density solid. An aerogel is a porous material derived from a gel, in which the liquid component of the gel has been replaced with a gas. The solvent removal is often done under supercritical conditions. During this process the network does not substantially shrink and a highly porous, low-density material can be obtained.

As used herein, “xerogel” refers to a three-dimensional solid derived from a green body gel, in which the liquid component of the gel has been removed by evaporation under ambient conditions or at an elevated temperature.

As used herein, “green body” means an un-sintered ceramic item, typically having an organic binder present.

As used herein, “white body” and “porous ceramic article” are interchangeable and refer to a pre-sintered ceramic item.

As used herein, “geometrically defined article” means an article the shape of which can be described with geometrical terms including 2-dimensional terms like circle, square, rectangle, and 3-dimensional terms like layer, cube, cuboid, sphere.

As used herein, “isotropic linear sintering behavior” means that the sintering of a porous body during the sintering process occurs essentially invariant with respect to the directions x, y and z. “Essentially invariant” means that the difference in sintering behavior with respect to the directions x, y and z is in a range of not more than about +/−5% or +/−2% or +/−1%.

As used herein, the term “crack” refers to a material segregation or partitioning (i.e., defect) that is a ratio equal to at least 5:1, at least 6:1, at least 7:1, at least 8:1, at least 10:1, at least 12:1, or at least 15:1 in any two dimensions.

A material or composition is “essentially free” or “substantially free” of a certain component within the meaning of the invention, if the material or composition does not contain said component as an essential feature. Thus, said component is not willfully added to the composition or material either as such or in combination with other components or ingredient of other components. A composition or material being essentially free of a certain component usually contains the component in an amount of less than about 1 wt. % or less than about 0.1 wt. % or less than about 0.01 wt. % (or less than about 0.05 mol/l solvent or less than about 0.005 mol/l solvent or less than about 0.0005 mol/l solvent) with respect to the whole composition or material. Ideally the composition or material does not contain the said component at all. However, sometimes the presence of a small amount of the said component is not avoidable e.g., due to impurities.

As used herein, “aliphatic group” means a saturated or unsaturated linear, branched, or cyclic hydrocarbon group. This term is used to encompass alkyl, alkenyl, and alkynyl groups, for example.

As used herein, “alkyl” means a linear or branched, cyclic or acyclic, saturated monovalent hydrocarbon having from one to thirty-two carbon atoms, e.g., methyl, ethyl, 1-propyl, 2-propyl, pentyl, and the like.

As used herein, “alkylene” means a linear saturated divalent hydrocarbon having from one to twelve carbon atoms or a branched saturated divalent hydrocarbon radical having from three to twelve carbon atoms, e.g., methylene, ethylene, propylene, 2-methylpropylene, pentylene, hexylene, and the like.

As used herein, “alkenyl” refers to a monovalent linear or branched unsaturated aliphatic group with one or more carbon-carbon double bonds, e.g., vinyl. Unless otherwise indicated, the alkenyl groups typically contain from one to twenty carbon atoms.

As used herein, the terms “hardenable” refers to a material that can be cured or solidified, e.g., by heating to remove solvent, heating to cause polymerization, chemical crosslinking, radiation-induced polymerization or crosslinking, or the like.

As used herein, “curing” means the hardening or partial hardening of a composition by any mechanism, e.g., by heat, light, radiation, e-beam, microwave, chemical reaction, or combinations thereof.

As used herein, “cured” refers to a material or composition that has been hardened or partially hardened (e.g., polymerized or crosslinked) by curing.

As used herein, “integral” refers to being made at the same time or being incapable of being separated without damaging one or more of the (integral) parts.

As used herein, the term “(meth)acrylate” is a shorthand reference to acrylate, methacrylate, or combinations thereof, “(meth)acrylic” is a shorthand reference to acrylic, methacrylic, or combinations thereof, and “(meth)acryl” is a shorthand reference to acryl and methacryl groups. “Acryl” refers to derivatives of acrylic acid, such as acrylates, methacrylates, acrylamides, and methacrylamides. By “(meth)acryl” is meant a monomer or oligomer having at least one acryl or methacryl groups, and linked by an aliphatic segment if containing two or more groups. As used herein, “(meth)acrylate-functional compounds” are compounds that include, among other things, a (meth)acrylate moiety.

As used herein, “non-crosslinkable” refers to a polymer that does not undergo crosslinking when exposed to actinic radiation or elevated heat. Typically, non-crosslinkable polymers are non-functionalized polymers such that they lack functional groups that would participate in crosslinking.

As used herein, “oligomer” refers to a molecule that has one or more properties that change upon the addition of a single further repeat unit.

As used herein, “polymer” refers to a molecule having one or more properties that do not change upon the addition of a single further repeat unit.

As used herein, “polymerizable slurry” and “polymerizable composition” each mean a hardenable composition that can undergo polymerization upon initiation (e.g., free-radical polymerization initiation). Typically, prior to polymerization (e.g., hardening), the polymerizable slurry or composition has a viscosity profile consistent with the requirements and parameters of one or more additive manufacturing (e.g., 3D printing) systems. In some embodiments, for instance, hardening comprises irradiating with actinic radiation having sufficient energy to initiate a polymerization or cross-linking reaction, for a “photopolymerizable slurry”. For instance, in some embodiments, ultraviolet (UV) radiation, e-beam radiation, or both, can be used.

As used herein, a “resin” contains all polymerizable components (monomers, oligomers and/or polymers) being present in a hardenable slurry or composition. The resin may contain only one polymerizable component compound or a mixture of different polymerizable compounds.

As used herein, “sintered article” refers to a gelled article that has been dried, heated to remove the organic matrix, and then further heated to reduce porosity and to densify. The density after sintering is at least 40 percent of the theoretical density. Articles having a density in a range of 40 to 93 percent of the theoretical density typically have open porosity (pores open to surface). Above 93 percent or 95 percent of the theoretical density, there are typically closed pores (no pores open to the surface).

As used herein, “thermoplastic” refers to a polymer that flows when heated sufficiently above its glass transition point and become solid when cooled.

As used herein, “thermoset” refers to a polymer that permanently sets upon curing and does not flow upon subsequent heating. Thermoset polymers are typically crosslinked polymers.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a”, “an”, and “the” are not intended to refer to only a singular entity, but include the general class of which a specific example may be used for illustration. The terms “a”, “an”, and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise. The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

In a first aspect, the present disclosure provides a method of making a non-oxide ceramic part. The method comprises:
a) obtaining a photopolymerizable slurry, the photopolymerizable slurry comprising non-oxide ceramic particles; at least one radiation curable monomer; a solvent; a photoinitiator; an inhibitor; and at least one sintering aid;
b) selectively curing the photopolymerizable slurry to obtain a gelled article;
c) drying the gelled article to form an aerogel article or a xerogel article;
d) heat treating the aerogel article or the xerogel article to form a porous ceramic article; and
e) sintering the porous ceramic article to obtain a sintered ceramic article.

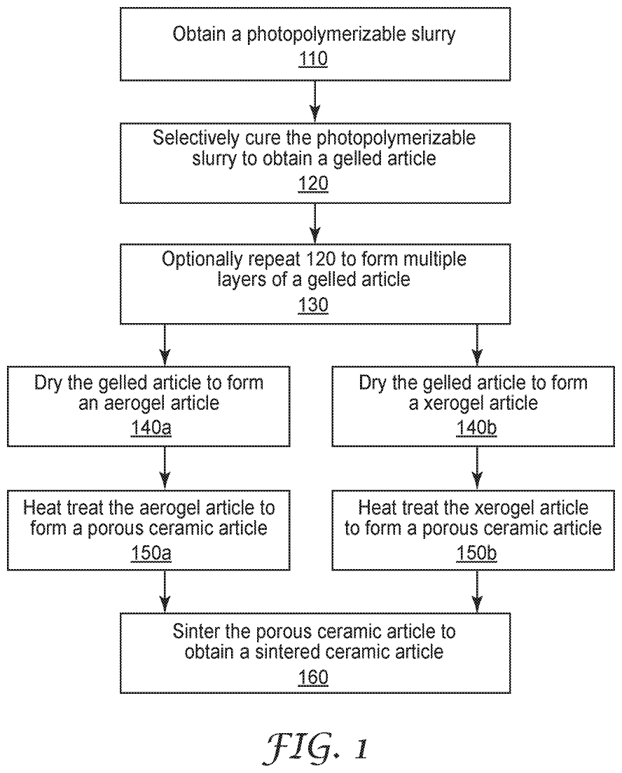

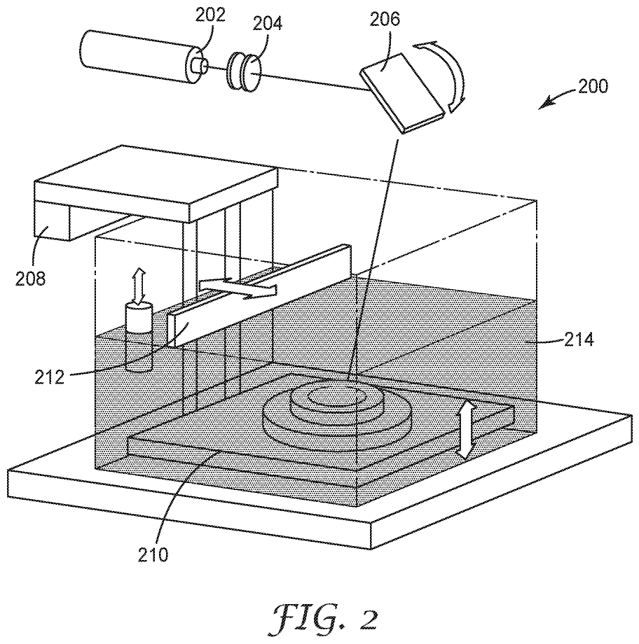

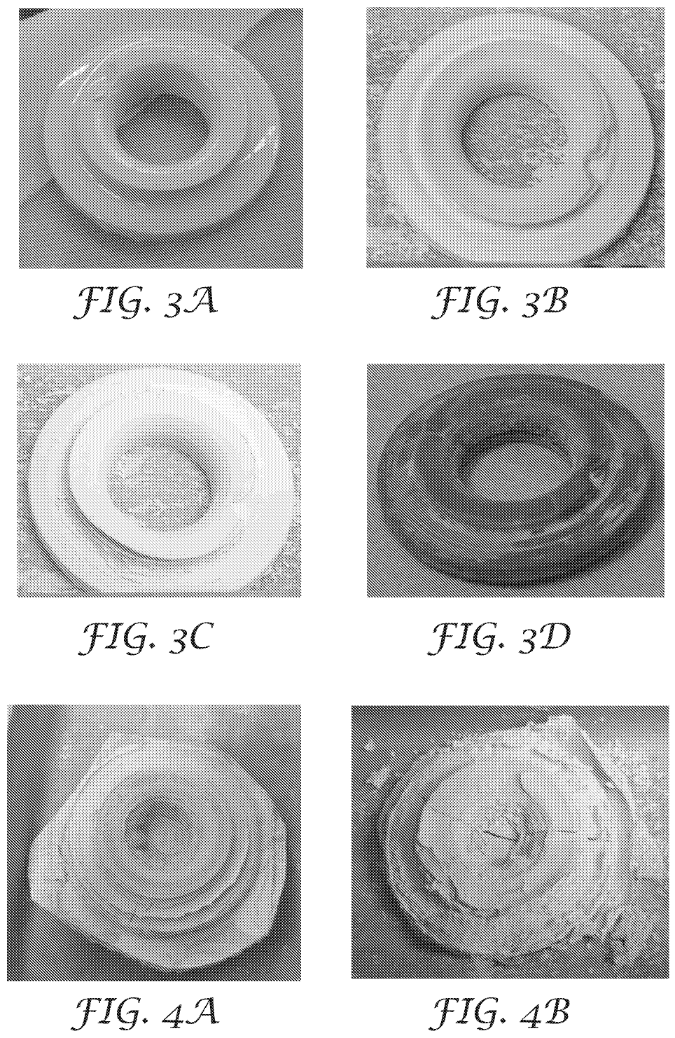

Stated another way, and referring to FIG. 1, a method of making a non-oxide ceramic part includes the step 110 of obtaining a photopolymerizable slurry and the step 120 of selectively curing the photopolymerizable slurry to obtain a gelled article. In certain embodiments, the selectively curing the photopolymerizable slurry comprises curing a portion of the photopolymerizable slurry having a thickness of 3 micrometers or greater, 4 micrometers or greater, 5 micrometers or greater, 7 micrometers or greater, 10 micrometers or greater, 15 micrometers or greater, 20 micrometers or greater, or 25 micrometers or greater; and having a thickness of 50 micrometers or less, 45 micrometers or less, 40 micrometers or less, 35 micrometers or less or 30 micrometers or less; such as between 3 micrometers and 50 micrometers.

The photopolymerizable slurry is typically introduced into a reservoir, cartridge, or other suitable container for use by or in an additive manufacturing device. The additive manufacturing device selectively cures the photopolymerizable slurry according to a set of computerized design instructions. Optionally, the method includes the step 130 of repeating the step 120 to form multiple (e.g., at least two, at least three, etc.) layers of a gelled article.

Referring again to FIG. 1, the method further includes either the step 140a of drying the gelled article to form an aerogel article or the step 140b of drying the gelled article to form a xerogel article. Optionally, the drying is performed by applying a supercritical fluid drying step. The method further includes either the step 150a of heat treating the aerogel article to form a porous ceramic article or the step 150b of heat treating the xerogel article to form a porous ceramic article; as well as the step 160 of sintering the porous ceramic article to obtain a sintered ceramic article. In certain embodiments, the sintered ceramic article comprises at least one feature integral to the sintered ceramic article having a dimension of 0.5 millimeters length or less. The photopolymerizable slurry includes non-oxide ceramic particles; at least one radiation curable monomer; a solvent; a photoinitiator; an inhibitor; and at least one sintering aid.

Additionally, it is to be understood that methods of manufacturing a 3D article described herein can include so-called “stereolithography/vat polymerization” 3D printing methods, and the selectively curing step may employ stereolithographic printing. Other techniques for three-dimensional manufacturing are known, and may be suitably adapted to use in the applications described herein. More generally, three-dimensional fabrication techniques continue to become available. All such techniques may be adapted to use with photopolymerizable slurries described herein, provided they offer compatible fabrication viscosities and resolutions for the specified article properties. Fabrication may be performed using any of the fabrication technologies described herein, either alone or in various combinations, using data representing a three-dimensional object, which may be reformatted or otherwise adapted as necessary for a particular printing or other fabrication technology.

It is entirely possible to form a 3D article from a photopolymerizable slurry described herein using vat polymerization (e.g., stereolithography). For example, in some cases, a method of printing a 3D article comprises retaining a photopolymerizable slurry described herein in a fluid state in a container and selectively applying energy to the photopolymerizable composition in the container to solidify at least a portion of a fluid layer of the photopolymerizable composition, thereby forming a hardened layer that defines a cross-section of the 3D article. Additionally, a method described herein can further comprise raising or lowering the hardened layer of photopolymerizable slurry (e.g., green body) to provide a new or second fluid layer of unhardened photopolymerizable slurry at the surface of the fluid in the container, followed by again selectively applying energy to the photopolymerizable slurry in the container to solidify at least a portion of the new or second fluid layer of the photopolymerizable slurry to form a second solidified layer that defines a second cross-section of the 3D article. Further, the first and second cross-sections of the 3D article can be bonded or adhered to one another in the z-direction (or build direction corresponding to the direction of raising or lowering recited above) by the application of the energy for solidifying the photopolymerizable slurry. Moreover, selectively applying energy to the photopolymerizable slurry in the container can comprise applying actinic radiation, such as UV radiation, visible radiation, or e-beam radiation, having a sufficient energy to cure the photopolymerizable slurry. A method described herein can also comprise planarizing a new layer of fluid photopolymerizable slurry provided by raising or lowering an elevator platform. Such planarization can be carried out, in some cases, by utilizing a wiper or roller or a recoater. Planarization corrects the thickness of one or more layers prior to curing the material by evening the dispensed material to remove excess material and create a uniformly smooth exposed or flat up-facing surface on the support platform of the printer.

It is further to be understood that the foregoing process can be repeated a selected number of times to provide the 3D article. For example, in some cases, this process can be repeated “n” number of times. Further, it is to be understood that one or more steps of a method described herein, such as a step of selectively applying energy to a layer of photopolymerizable slurry, can be carried out according to an image of the 3D article in a computer-readable format. Suitable stereolithography printers include the Viper Pro SLA, available from 3D Systems, Rock Hill, S.C. and the Asiga PICO PLUS 39, available from Asiga USA, Anaheim Hills, Calif.

FIG. 2 shows an exemplary stereolithography apparatus (“SLA”) that may be used with the photopolymerizable slurries and methods described herein. In general, the SLA 200 may include a laser 202, optics 204, a steering lens 206, an elevator 208, a platform 210, and a straight edge 212, within a vat 214 filled with the photopolymerizable slurry. In operation, the laser 202 is steered across a surface of the photopolymerizable slurry to cure a cross-section of the photopolymerizable slurry, after which the elevator 208 slightly lowers the platform 210 and another cross section is cured. The straight edge 212 may sweep the surface of the cured composition between layers to smooth and normalize the surface prior to addition of a new layer. In other embodiments, the vat 214 may be slowly filled with liquid resin while an article is drawn, layer by layer, onto the top surface of the photopolymerizable slurry.

A related technology, vat polymerization with Digital Light Processing (“DLP”), also employs a container of curable polymer (e.g., photopolymerizable slurry). However, in a DLP based system, a two-dimensional cross section is projected onto the curable material to cure the desired section of an entire plane transverse to the projected beam at one time. All such curable polymer systems as may be adapted to use with the photopolymerizable slurries described herein are intended to fall within the scope of the terms “vat polymerization” and “stereolithography” as used herein. In certain embodiments, an apparatus adapted to be used in a continuous mode may be employed, such as an apparatus commercially available from Carbon 3D, Inc. (Redwood City, Calif.), for instance as described in U.S. Pat. Nos. 9,205,601 and 9,360,757 (both to DeSimone et al.).

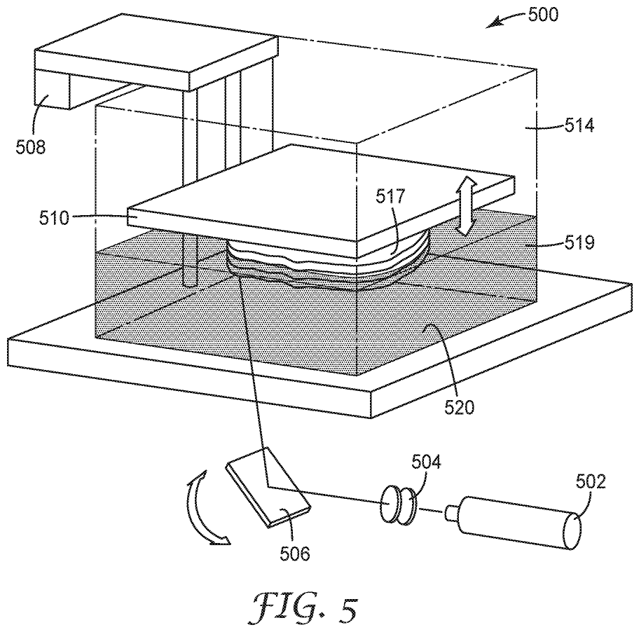

Referring to FIG. 5, a general schematic is provided of another SLA apparatus that may be used with photopolymerizable slurries and methods described herein. In general, the apparatus 500 may include a laser 502, optics 504, a steering lens 506, an elevator 508, and a platform 510, within a vat 514 filled with the photopolymerizable slurry 519. In operation, the laser 502 is steered through a wall 520 (e.g., the floor) of the vat 514 and into the photopolymerizable slurry to cure a cross-section of the photopolymerizable slurry 519 to form an article 517, after which the elevator 508 slightly raises the platform 510 and another cross section is cured. Hence, the radiation may be directed through a wall of a container (e.g., a vat) holding the photopolymerizable slurry, such as a side wall or a bottom wall.

More generally, the photopolymerizable slurry is typically cured using actinic radiation, such as UV radiation, e-beam radiation, visible radiation, or any combination thereof. The skilled practitioner can select a suitable radiation source and range of wavelengths for a particular application without undue experimentation.

After the 3D article has been formed, it is typically removed from the additive manufacturing apparatus and rinsed, (e.g., an ultrasonic, or bubbling, or spray rinse in a solvent, which would dissolve a portion of the uncured photopolymerizable slurry but not the cured, solid state article (e.g., green body). Any other conventional method for cleaning the article and removing uncured material at the article surface may also be utilized. At this stage, the three-dimensional article typically has sufficient green strength for handling in the remaining (e.g., optional) steps of the method.

A photopolymerizable slurry described herein in a cured state (e.g., a gelled body), in some embodiments, can exhibit one or more desired properties. A photopolymerizable slurry in a “cured” state can comprise a photopolymerizable slurry that includes a polymerizable component that has been at least partially polymerized and/or crosslinked. For instance, in some instances, a gelled article is at least about 10% polymerized or crosslinked or at least about 30% polymerized or crosslinked. In some cases, a gelled article is at least about 50%, at least about 70%, at least about 80%, or at least about 90% polymerized or crosslinked. A gelled article can also be between about 10% and about 99% polymerized or crosslinked.

The article surface, as well as the bulk article itself, typically still retains uncured photopolymerizable material, suggesting further cure. Removing residual uncured photopolymerizable composition is particularly useful when the article is going to subsequently be post cured, to minimize uncured residual photopolymerizable composition from undesirably curing directly onto the article.

Further curing can be accomplished by further irradiating with actinic radiation, heating, or both, plus optionally soaking the gelled article with another solvent (e.g., diethylene glycol ethyl ether or ethanol). Exposure to actinic radiation can be accomplished with any convenient radiation source, generally UV radiation, visible radiation, and/or e-beam radiation, for a time ranging from about 10 to over 60 minutes. Heating is generally carried out at a temperature in the range of about 35-80° C., for a time ranging from about 10 to over 60 minutes in an inert atmosphere. So called post cure ovens, which combine UV radiation and thermal energy, are particularly well suited for use in the postcure process(es). In general, post curing improves the mechanical properties and stability of the three-dimensional article relative to the same three-dimensional article that is not post cured.

The components of the photopolymerizable slurry (e.g., non-oxide ceramic particles, radiation curable monomer, photoinitiator, inhibitor, and sintering aid) are each discussed in detail below.

### Non-Oxide Ceramic Particles

The photopolymerizable compositions of the present disclosure include particles of at least one non-oxide ceramic material.

Preferably, the non-oxide ceramic particles are selected from the group consisting of silicon carbide, silicon nitride (Si₃N₄), boron carbide (B₄C), titanium diboride (TiB₂), zirconium diboride (ZrB₂), boron nitride (BN), titanium carbide (TiC), zirconium carbide (ZrC), aluminium nitride (AlN), calcium hexaboride (CaB₆), MAX phase (Mₙ₊₁AXₙ), and any combination thereof. In select embodiments, high-purity powder is used, in which the total content of metal impurities is preferably less than 100 ppm, particularly preferably less than 50 ppm. In alternate embodiments, a powder is used having a total content of metal impurities of about 2,000 ppm.

Suitable silicon nitride particles include for instance and without limitation powders having a mean particle or agglomerate size (D₅₀) of 0.5-20 micrometers, such as 1-10 micrometers. The oxygen content of silicon nitride powder is preferably less than 2 wt. % and the total carbon content is preferably less than 0.35 wt. %. A commercially available silicon nitride powder can be obtained under the trade designation SILZOT from AlzChem Group AG (Trastber, Germany).

Suitable boron carbide particles include for instance and without limitation, B₄C powders having a purity of 97% by weight or higher, and a mean particle size (D₅₀) of 0.1 to 8 micrometers. An example of a suitable boron carbide powder is 3M Boron Carbide Powder commercially available from 3M Company (St. Paul, Minn.).

Suitable titanium diboride particles include for instance and without limitation, TiB₂ powders having a mean particle size (D₅₀) of about 2-20 micrometers. An example of a suitable titanium diboride powder is 3M Titanium Diboride Powder commercially available from 3M Company.

Suitable zirconium diboride particles include for instance and without limitation, high purity or ultra-high purity ZrB₂ powders available from American Elements (Los Angeles, Calif.).

Suitable boron nitride particles include for instance and without limitation, agglomerates of platelet-shaped, hexagonal boron nitride primary particles, wherein the hexagonal boron nitride primary particles are connected to one another by means of an inorganic binding phase. The inorganic binding phase comprises at least one nitride and/or oxynitride. The nitrides or oxynitrides are preferably compounds of the elements aluminum, silicon, titanium and boron. An example of a suitable boron nitride powder is 3M Boron Nitride Cooling Fillers Platelets commercially available from 3M Company.

Suitable titanium carbide particles include for instance, TiC powders having a mean particle size (D₅₀) of 1 to 3 micrometers. An example of a suitable titanium carbide powder is TiC Grade High Vacuum 120 commercially available from HC-Starck (Munich, Germany).

Suitable zirconium carbide particles include for instance, ZrC powders having a mean particle size (D₅₀) of 3 to 5 micrometers. An example of a suitable zirconium carbide powder is ZrC Grade B commercially available from HC-Starck.

Suitable aluminum nitride particles include for instance, AN powders having a mean particle size (D₅₀) of 0.8 to 2 micrometers. An example of a suitable aluminum nitride powder is AlN Grade C commercially available from HC-Starck.

Suitable calcium hexaboride particles include for instance, CaB₆ powders commercially available from 3M Company as 3M Calcium Hexaboride.

MAX phase particles are layered hexagonal carbides and nitrides having the general formula of Mₙ₊₁AXₙ, wherein n=1 to 3, M is an early transition metal, A is an A-group element, and X is independently selected from carbon and nitrogen. The A-group elements are preferably elements 13-16. An example of a suitable MAX phase powder is MAXTHAL 312 powder commercially available from Kanthal (Hallstahammar, Sweden).

In some embodiments, the photopolymerizable slurry comprises 20 wt. % or greater non-oxide ceramic particles, based on the total weight of the photopolymerizable slurry, 21 wt. % or greater, 22 wt. % or greater, 23 wt. % or greater, 24 wt. % or greater, 25 wt. % or greater, 26 wt. % or greater, 27 wt. % or greater, or 28 wt. % or greater; and less than 30 wt. %, 29.5 wt. % or less, 28.5 wt. % or less, 27.5 wt. % or less, 26.5 wt. % or less, 25.5 wt. % or less, or 24.5 wt. % or less, non-oxide ceramic particles, based on the total weight of the photopolymerizable slurry. Stated another way, the photopolymerizable slurry can include between 20 percent by weight and up to but not including 30 percent by weight of non-oxide ceramic particles, based on the total weight of the photopolymerizable slurry.

The non-oxide ceramic particles typically comprise an average (mean) particle size diameter (i.e., D₅₀) of 250 nanometers (nm) or greater, 350 nm or greater, 500 nm or greater, 750 nm or greater, 1 micrometer or greater, 1.25 micrometers or greater, 1.5 micrometers or greater, 1.75 micrometers or greater, 2 micrometers or greater, 2.5 micrometers or greater, 3.0 micrometers or greater, 3.5 micrometers or greater, 4.0 micrometers or greater, or 4.5 micrometers or greater; and a D₅₀ of 10 micrometers or less, 9.5 micrometers or less, 9 micrometers or less, 8.5 micrometers or less, 8 micrometers or less, 7.5 micrometers or less, 7 micrometers or less, 6.5 micrometers or less, 6 micrometers or less, 5.5 micrometers or less, 5 micrometers or less, 4.5 micrometers or less, 3 micrometers or less, 2 micrometers or less, 1.5 micrometers or less, or 1 micrometer or less. Stated another way, the non-oxide ceramic particles may have an average particle size diameter (D₅₀) of 1 micrometer to 10 micrometers, of 500 nanometers to 1.5 micrometers, or of 250 nm to 1 micrometer. The average (mean) particle size (D₅₀) refers to that particle diameter at which 50 percent by volume of the particles in a distribution of particles have that diameter or a smaller diameter, as measured by laser diffraction. Preferably, the average particle size is of the primary particles.

### Sintering Aid

The photopolymerizable compositions of the present disclosure include at least one sintering aid. Often, sintering aids assist by removing oxygen during the sintering process. Also, a sintering aid may provide a phase that melts from a solid to a liquid at a lower temperature than the non-oxide ceramic material, or may provide some alternate mechanism that improves transport of ceramic ions and thus increases densification as compared to a composition not containing the sintering aid.

Suitable sintering aids are not particularly limited, and may include rare earth oxides, alkaline earth oxides, alkali oxides, and combinations thereof. Materials that yield liquids at the sintering temperature of the non-oxide ceramic particles can be useful.

Rare earth oxides include cerium oxide (e.g., CeO₂), dysprosium oxide (e.g., Dy₂O₃), erbium oxide (e.g., Er₂O₃), europium oxide (e.g., Eu₂O₃), gadolinium (e.g., Gd₂O₃), holmium oxide (e.g., Ho₂O₃), lanthanum oxide (e.g., La₂O₃), lanthanum aluminum oxide (La AlO₃), lutetium oxide (e.g., Lu₂O₃), neodymium oxide (e.g., Nd₂O₃), praseodymium oxide (e.g., Pr₆O₁₁), samarium oxide (e.g., Sm₂O₃), terbium (e.g., Tb₂O₃), thorium oxide (e.g., Th₄O₇), thulium (e.g., Tm₂O₃), and ytterbium oxide (e.g., Yb₂O₃), and combinations thereof.

Alkaline earth oxides include barium oxide (BaO), calcium oxide (CaO), strontium oxide (SrO), magnesium oxide (MgO), beryllium oxide (BeO) and combinations thereof.

Alkali oxides include lithium oxide (Li₂O₂), sodium oxide (Na₂O₂), potassium oxide (K₂O), rubidium oxide (Rb₂O), and cesium oxide (Cs₂O), and combinations thereof.

In some embodiments, a mixture of an alkaline earth oxide and a rare earth oxide is preferable, such as a combination of aluminum oxide and yttrium oxide.

Additional suitable sintering aids include for instance and without limitation, boron, carbon, magnesium, aluminum, silicon, titanium, vanadium, chromium, iron, nickel, copper, aluminum nitride, alumina, ethylsilicate, sodium silicate with Mg(NO₃)₂, other glasses, Fe₂O₃, MgF₂, and combinations thereof.

In many embodiments, the at least one sintering aid comprises aluminum oxide, yttrium oxide, zirconium oxide, silicon oxide, titanium oxide, magnesium oxide, calcium oxide, strontium oxide, barium oxide, lithium oxide, sodium oxide, potassium oxide, carbon, boron, boron carbide, aluminum, aluminum nitride, or combinations thereof. For instance, suitable commercially available sintering aids include Calcined Alumina from Almatis (Ludwigshafen, Germany) and Yttrium Oxide from Treibacher Industrie AG (Althofen, Austria).

### Radiation Curable Monomer

The photopolymerizable slurry described in the present text comprises one or more radiation curable monomers being part of or forming an organic matrix.

The radiation curable monomer(s) being present in the photopolymerizable slurry can be described as first, second, third, etc., monomer. The nature and structure of the radiation curable monomer(s) is not particularly limited unless the desired result cannot be achieved. In some embodiments, the at least one radiation curable monomer comprises an acrylate.

Upon polymerization, the radiation curable monomers form a network with the (preferably) homogeneously dispersed non-oxide ceramic particles.

According to one embodiment the photopolymerizable slurry contains as a first monomer a polymerizable surface modification agent. Optionally, at least a portion of the non-oxide ceramic particles in the photopolymerizable slurry may comprise a surface modifier attached to a surface of the non-oxide ceramic particles. A surface modifier may help to improve compatibility of the particles contained in the slurry with an organic matrix material also present in the slurry. Surface modifiers may be represented by the formula A-B, where the A group is capable of attaching to the surface of a non-oxide ceramic particle and the B group is radiation curable.

Group A can be attached to the surface of the non-oxide ceramic particle by adsorption, formation of an ionic bond, formation of a covalent bond, or a combination thereof. Examples of suitable Group A moieties include acidic moieties (like carboxylic acid groups, phosphoric acid groups, sulfonic acid groups and anions thereof) and silanes. Group B comprises a radiation curable moiety. Examples of suitable Group B moieties include vinyl, in particular acryl or methacryl moieties.

Suitable surface modifiers comprise polymerizable carboxylic acids and/or anions thereof, polymerizable sulfonic acids and/or anions thereof, polymerizable phosphoric acids and/or anions thereof, and polymerizable silanes. Suitable surface modification agents are further described, for example, in WO 2009/085926 (Kolb et al.), the disclosure of which is incorporated herein by reference.

An example of a radically polymerizable surface modifier is a polymerizable surface modification agent comprising an acidic moiety or anion thereof, e.g. a carboxylic acid group. Exemplary acidic radically polymerizable surface modifiers include acrylic acid, methacrylic acid, beta-carboxyethyl acrylate, and mono-2-(methacryloxyethyl)succinate.

Exemplary radically polymerizable surface modifiers can be reaction products of hydroxyl-containing polymerizable monomers with cyclic anhydrides such as succinic anhydride, maleic anhydride and phthalic anhydride. Exemplary polymerization hydroxyl-containing monomers include hydroxyethyl acrylate, hydroxyethyl methacrylate, hydroxypropyl acrylate, hydroxypropyl methacrylate, hydroxyl butyl acrylate, and hydroxybutyl methacrylate. Acryloxy and methacryloxy functional polyethylene oxide, and polypropylene oxide may also be used as the polymerizable hydroxyl-containing monomers.

An exemplary radically polymerizable surface modifier for imparting both polar character and reactivity to the non-oxide ceramic nanoparticles is mono(methacryloxypolyethyleneglycol) succinate.

Another example of a radically polymerizable surface modifier is a polymerizable silane. Exemplary polymerizable silanes include methacryloxyalkyltrialkoxysilanes, or acryloxy-alkyltrialkoxysilanes (e.g., 3-methacryloxypropyltrimethoxysilane, 3-acryloxypropyltrimethoxy-silane, and 3-(methacryloxy)propyltriethoxysilane; as 3-(methacryloxy)propylmethyldimethoxy-silane, and 3-(acryloxypropyl)methyldimethoxysilane); methacryloxyalkyldialkylalkoxysilanes or acyrloxyalkyldialkylalkoxysilanes (e.g., 3-(methacryloxy)propyldimethylethoxysilane); mercapto-alkyltrialkoxylsilanes (e.g., 3-mercaptopropyltrimethoxysilane); aryltrialkoxysilanes (e.g., styrylethyltrimethoxysilane); vinylsilanes (e.g., vinylmethyldiacetoxysilane, vinyldimethylethoxy-silane, vinylmethyldiethoxysilane, vinyltrimethoxysilane, vinyltriethoxysilane, vinyltriacetoxysilane, vinyltriisopropoxysilane, vinyltrimethoxysilane, and vinyltris(2-methoxyethoxy)silane).

A surface modifier can be added to the non-oxide ceramic particles using conventional techniques. The surface modifier can be added before or after any removal of at least a portion of carboxylic acids and/or anions thereof from the non-oxide ceramic particle-based slurry. The surface modification agent can be added before or after removal of water from a non-oxide ceramic particle-based slurry. The organic matrix can be added before or after surface modification or simultaneously with surface modification. Various methods of adding the surface modification agent are further described, for example, in WO 2009/085926 (Kolb et al.), the disclosure of which is incorporated herein by reference.

The surface modification reactions can occur at room temperature (e.g., 20° C. to 25° C.) or at an elevated temperature (e.g., up to 95° C.). When the surface modifiers are acids such as carboxylic acids, the non-oxide ceramic particles typically can be surface-modified at room temperature. When the surface modification agents are silanes, the non-oxide ceramic particles are typically surface modified at elevated temperatures.

The first monomer can function as a polymerizable surface modification agent. Multiple first monomers can be used. The first monomer can be the only kind of surface modifiers or can be combined with one or more other non-polymerizable surface modifiers. In some embodiments, the amount of the first monomer is at least 20 wt. % based on a total weight of polymerizable material. For example, the amount of the first monomer is often at least 25 wt. %, at least 30 wt. %, at least 35 wt. %, or at least 40 wt. %. The amount of the first monomer can be up to 100 wt. %, up to 90 wt. %, up to 80 wt. %, up to 70 wt. %, up to 60 wt. %, or up to 50 wt. %. Some photopolymerizable slurries contain 20 to 100 wt. %, 20 to 80 wt. %, 20 to 60 wt. %, 20 to 50 wt. %, or 30 to 50 wt. % of the first monomer based on a total weight of polymerizable material.

The first monomer (i.e., the polymerizable surface modification agent) can be the only monomer in the polymerizable material or it can be combined with one or more second monomers, as described in further detail below.

According to one embodiment, the photopolymerizable slurry comprises one or more second monomers comprising at least one or two radiation curable moieties. In particular, the second monomers comprising at least two radiation curable moieties may act as crosslinker(s) during the gel-forming step. Any suitable second monomer that does not have a surface modification group can be used. The second monomer does not have a group being capable of attaching to the surface of a non-oxide ceramic particle.

A successful build typically requires a certain level of green body gel strength as well as shape resolution. A crosslinked approach often allows for greater green body gel strength to be realized at a lower energy dose since the polymerization creates a stronger network. In some examples, higher energy doses have been applied to increase layer adhesion of non-crosslinked systems. While an article is successfully built, the higher energy often impacts the resolution of the final article, causing overbuild to potentially occur, especially in the case of highly translucent materials where the light and with it the cure depth can penetrate further into the material. The presence of the monomer having a plurality of polymerizable groups tends to enhance the strength of the gel composition formed when the photopolymerizable slurry is polymerized. Such gel compositions can be easier to process without cracking. The amount of the monomer with a plurality of the polymerizable groups can be used to adjust the flexibility and the strength of the green body gel, and indirectly optimize the green body gel resolution and final article resolution.

In the case where the light source is applied from below, it has been found that applying e.g., crosslink chemistry may help to increase the strength of the adhesion between layers so that when the build platform is raised after the cure step, the newly cured layer moves with the building shape, rather than being separated from the rest of the build and left behind on the transparent film, which would be considered a failed build. A successful build could be defined as the scenario when the material adheres better to the previously cured layers than the build tray film, to allow for a three-dimensional structure to be grown one layer at a time. This performance could in theory be achieved by applying an increased energy dose (higher power, or longer light exposure) to provide a stronger adhesion up to a certain point characteristic of the bulk material. However, in a fairly transparent system where light absorbing additives are not present a higher energy exposure will eventually provide a depth of cure significantly greater than the “slice thickness”, creating an over-cured situation where the resolution of the part is significantly beyond that of the “slice thickness”.

Adding a radiation curable component comprising at least two radiation curable moieties to the photopolymerizable slurry described herein may facilitate the optimization of resolution as well as green body strength. In the case of transforming the green body into a fully dense ceramic, increased green body gel strength aids in the robustness of the post-building procedures.

That is, the optional second monomer does not have a carboxylic acid group or a silyl group. The second monomers are often polar monomers (e.g., non-acidic polar monomers), monomers having a plurality of polymerizable groups, alkyl (meth)acrylates and mixtures thereof.

The overall composition of the polymerizable material is often selected so that the polymerized material is soluble in a solvent medium. Homogeneity of the organic phase is often preferable to avoid phase separation of the organic component in the gel composition. This tends to result in the formation of smaller and more homogeneous pores (pores with a narrower size distribution) in the subsequently formed aerogel or xerogel. Further, the overall composition of the polymerizable material can be selected to adjust compatibility with a solvent medium and to adjust the strength, flexibility, and uniformity of the gel composition. Still further, the overall composition of the polymerizable material can be selected to adjust the burnout characteristics of the organic material prior to sintering.

In many embodiments, the second monomer includes a monomer having a plurality of polymerizable groups. The number of polymerizable groups can be in a range of 2 to 6 or even higher. In many embodiments, the number of polymerizable groups is in a range of 2 to 5 or 2 to 4. The polymerizable groups are typically (meth)acryloyl groups.

Exemplary monomers with two (meth)acryloyl groups include 1,2-ethanediol diacrylate, 1,3-propanediol diacrylate, 1,9-nonanediol diacrylate, 1,12-dodecanediol diacrylate, 1,4-butanediol diacrylate, 1,6-hexanediol diacrylate, butylene glycol diacrylate, bisphenol A diacrylate, diethylene glycol diacrylate, triethylene glycol diacrylate, tetraethylene glycol diacrylate, tripropylene glycol diacrylate, polyethylene glycol diacrylate, polypropylene glycol diacrylate, polyethylene/polypropylene copolymer diacrylate, polybutadiene di(meth)acrylate, propoxylated glycerin tri(meth)acrylate, and neopentylglycol hydroxypivalate diacrylate modified caprolactone.

Exemplary monomers with three or four (meth)acryloyl groups include, but are not limited to, trimethylolpropane triacrylate (e.g., commercially available under the trade designation TMPTA-N from Cytec Industries, Inc. (Smyrna, Ga., USA) and under the trade designation SR-351 from Sartomer (Exton, Pa., USA)), pentaerythritol triacrylate (e.g., commercially available under the trade designation SR-444 from Sartomer), ethoxylated (3) trimethylolpropane triacrylate (e.g., commercially available under the trade designation SR-454 from Sartomer), ethoxylated (4) pentaerythritol tetraacrylate (e.g., commercially available under the trade designation SR-494 from Sartomer), tris(2-hydroxyethylisocyanurate) triacrylate (e.g., commercially available under the trade designation SR-368 from Sartomer), a mixture of pentaerythritol triacrylate and pentaerythritol tetraacrylate (e.g., commercially available from Cytec Industries, Inc., under the trade designation PETIA with an approximately 1:1 ratio of tetraacrylate to triacrylate and under the trade designation PETA-K with an approximately 3:1 ratio of tetraacrylate to triacrylate), pentaerythritol tetraacrylate (e.g., commercially available under the trade designation SR-295 from Sartomer), and di-trimethylolpropane tetraacrylate (e.g., commercially available under the trade designation SR-355 from Sartomer).

Exemplary monomers with five or six (meth)acryloyl groups include, but are not limited to, dipentaerythritol pentaacrylate (e.g., commercially available under the trade designation SR-399 from Sartomer) and a hexa-functional urethane acrylate (e.g., commercially available under the trade designation CN975 from Sartomer).

Some photopolymerizable slurry compositions contain 0 to 80 wt. % of a second monomer having a plurality of polymerizable groups based on a total weight of the polymerizable material. For example, the amount can be in a range of 10 to 80 wt. %, 20 to 80 wt. %, 30 to 80 wt. %, 40 to 80 wt. %, 10 to 70 wt. %, 10 to 50 wt. %, 10 to 40 wt. %, or 10 to 30 wt. %.

In some embodiments, the optional second monomer is a polar monomer. As used herein, the term “polar monomer” refers to a monomer having a free radical polymerizable group and a polar group. The polar group is typically non-acidic and often contains a hydroxyl group, a primary amido group, a secondary amido group, a tertiary amido group, an amino group, or an ether group (i.e., a group containing at least one alkylene-oxy-alkylene group of formula —R—O—R— where each R is an alkylene having 1 to 4 carbon atoms).

Suitable optional polar monomers having a hydroxyl group include, but are not limited to, hydroxyalkyl (meth)acrylates (e.g., 2-hydroxyethyl (meth)acrylate, 2-hydroxypropyl (meth)acrylate, 3-hydroxypropyl (meth)acrylate, and 4-hydroxybutyl (meth)acrylate), and hydroxyalkyl (meth)acrylamides (e.g., 2-hydroxyethyl (meth)acrylamide or 3-hydroxypropyl (meth)acrylamide), ethoxylated hydroxyethyl (meth)acrylate (e.g., monomers commercially available from Sartomer under the trade designation CD570, CD571, and CD572), and aryloxy substituted hydroxyalkyl (meth)acrylates (e.g., 2-hydroxy-2-phenoxypropyl (meth)acrylate).

Exemplary polar monomers with a primary amido group include (meth)acrylamide. Exemplary polar monomers with secondary amido groups include, but are not limited to, N-alkyl (meth)acrylamides such as N-methyl (meth)acrylamide, N-ethyl (meth)acrylamide, N-isopropyl (meth)acrylamide, N-tert-octyl (meth)acrylamide, and N-octyl (meth)acrylamide. Exemplary polar monomers with a tertiary amido group include, but are not limited to, N-vinyl caprolactam, N-vinyl-2-pyrrolidone, (meth)acryloyl morpholine, and N,N-dialkyl (meth)acrylamides such as N,N-dimethyl (meth)acrylamide, N,N-diethyl (meth)acrylamide, N,N-dipropyl (meth)acrylamide, and N,N-dibutyl (meth)acrylamide.

Polar monomers with an amino group include various N,N-dialkylaminoalkyl (meth)acrylates and N,N-dialkylaminoalkyl (meth)acrylamides. Examples include, but are not limited to, N,N-dimethyl aminoethyl (meth)acrylate, N,N-dimethylaminoethyl (meth)acrylamide, N,N-dimethylaminopropyl (meth)acrylate, N,N-dimethylaminopropyl (meth)acrylamide, N,N-diethylaminoethyl (meth)acrylate, N,N-diethylaminoethyl (meth)acrylamide, N,N-diethylaminopropyl (meth)acrylate, and N,N-diethylaminopropyl (meth)acrylamide.

Exemplary polar monomers with an ether group include, but are not limited to, alkoxylated alkyl (meth)acrylates such as ethoxyethoxyethyl (meth)acrylate, 2-methoxyethyl (meth)acrylate, and 2-ethoxyethyl (meth)acrylate; and poly(alkylene oxide) (meth)acrylates such as poly(ethylene oxide) (meth)acrylates, and poly(propylene oxide) (meth)acrylates. The poly(alkylene oxide) acrylates are often referred to as poly(alkylene glycol) (meth)acrylates. These monomers can have any suitable end group such as a hydroxyl group or an alkoxy group. For example, when the end group is a methoxy group, the monomer can be referred to as methoxy poly(ethylene glycol) (meth)acrylate.

Suitable alkyl (meth)acrylates that can be used as a second monomer can have an alkyl group with a linear, branched, or cyclic structure. Examples of suitable alkyl (meth)acrylates include, but are not limited to, methyl (meth)acrylate, ethyl (meth)acrylate, n-propyl (meth)acrylate, isopropyl (meth)acrylate, n-butyl (meth)acrylate, isobutyl (meth)acrylate, n-pentyl (meth)acrylate, 2-methylbutyl (meth)acrylate, n-hexyl (meth)acrylate, cyclohexyl (meth)acrylate, 4-methyl-2-pentyl (meth)acrylate, 2-ethylhexyl (meth)acrylate, 2-methylhexyl (meth)acrylate, n-octyl (meth)acrylate, isooctyl (meth)acrylate, 2-octyl (meth)acrylate, isononyl (meth)acrylate, isoamyl (meth)acrylate, 3,3,5-trimethylcyclohexyl (meth)acrylate, n-decyl (meth)acrylate, isodecyl (meth)acrylate, isobornyl (meth)acrylate, 2-propylheptyl (meth)acrylate, isotridecyl (meth)acrylate, isostearyl (meth)acrylate, octadecyl (meth)acrylate, 2-octyldecyl (meth)acrylate, dodecyl (meth)acrylate, lauryl (meth)acrylate, and heptadecanyl (meth)acrylate. In some embodiments, the alkyl (meth)acrylates are a mixture of various isomers having the same number of carbon atoms as described in PCT Patent Application Publication WO 2014/151179 (Colby et al.). For example, an isomer mixture of octyl (meth)acrylate can be used.

The amount of a second monomer that is a polar monomer and/or an alkyl (meth)acrylate monomer is often in a range of 0 to 40 wt. %, 0 to 35 wt. %, 0 to 30 wt. %, 5 to 40 wt. %, or 10 to 40 wt. % based on a total weight of the polymerizable material.

The total amount of polymerizable material is often at least 10 wt. %, at least 12 wt. %, at least 15 wt. %, or at least 18 wt. % based on the total weight of the photopolymerizable slurry. The amount of polymerizable material can be up to 50 wt. %, up to 40 wt. %, up to 30 wt. %, or up to 20 wt. %, based on the total weight of the photopolymerizable slurry. For example, the amount of polymerizable material can be in a range of 10-50 wt. %, 15-40 wt. %, 15-30 wt. %, or 10-20 wt. % based on the total weight of the photopolymerizable slurry.

Overall, the polymerizable material typically contains 20 to 100 wt. % first monomer and 0 to 80 wt. % second monomer based on a total weight of polymerizable material. For example, polymerizable material includes 30 to 100 wt. % first monomer and 0 to 70 wt. % second monomer, 30 to 90 wt. % first monomer and 10 to 70 wt. % second monomer, 30 to 80 wt. % first monomer and 20 to 70 wt. % second monomer, 30 to 70 wt. % first monomer and 30 to 70 wt. % second monomer, 40 to 90 wt. % first monomer and 10 to 60 wt. % second monomer, 40 to 80 wt. % first monomer and 20 to 60 wt. % second monomer, 50 to 90 wt. % first monomer and 10 to 50 wt. % second monomer, or 60 to 90 wt. % first monomer and 10 to 40 wt. % second monomer.

Photoinitiator

Photopolymerizable slurries described herein further comprise one or more photoinitiators. In certain embodiments the photoinitiator(s) can be characterized by being soluble in a solvent contained in the slurry and/or absorbing radiation within a range from 200 to 500 or from 300 to 470 nm. The photoinitiator should be able to start or initiate the curing or hardening reaction of the radiation curable component(s) being present in the photopolymerizable slurry.

The following classes of photoinitiator(s) can be used: a) two-component system where a radical is generated through abstraction of a hydrogen atom from a donor compound; b) one component system where two radicals are generated by cleavage; and/or c) a system comprising an iodonium salt, a visible light sensitizer, and an electron donor compound.

Examples of photoinitiators according to type (a) typically contain a moiety selected from benzophenone, xanthone or quinone in combination with an aliphatic amine.

Examples of photoinitiators according to type (b) typically contain a moiety selected form benzoin ether, acetophenone, benzoyl oxime or acyl phosphine. Suitable exemplary photoinitiators are those available under the trade designation OMNIRAD from IGM Resins (Waalwijk, The Netherlands) and include 1-hydroxycyclohexyl phenyl ketone (OMNIRAD 184), 2,2-dimethoxy-1,2-diphenylethan-1-one (OMNIRAD 651), bis(2,4,6 trimethylbenzoyl)phenylphosphineoxide (OMNIRAD 819), 1-[4-(2-hydroxyethoxy)phenyl]-2-hydroxy-2-methyl-1-propane-1-one (OMNIRAD 2959), 2-benzyl-2-dimethylamino-1-(4-morpholinophenyl)butanone (OMNIRAD 369), 2-methyl-1-[4-(methylthio)phenyl]-2-morpholinopropan-1-one (OMNIRAD 907), 2-hydroxy-2-methyl-1-phenyl propan-1-one (OMNIRAD 1173), 2, 4, 6-trimethylbenzoyldiphenylphosphine oxide (OMNIRAD TPO), and 2, 4, 6-trimethylbenzoylphenyl phosphinate (OMNIRAD TPO-L). Additional suitable photoinitiators include for example and without limitation, Oligo[2-hydroxy-2-methyl-1-[4-(1-methylvinyl)phenyl]propanone] ESACURE ONE (Lamberti S.p.A., Gallarate, Italy), 2-hydroxy-2-methylpropiophenone, benzyl dimethyl ketal, 2-methyl-2-hydroxypropiophenone, benzoin methyl ether, benzoin isopropyl ether, anisoin methyl ether, aromatic sulfonyl chlorides, photoactive oximes, and combinations thereof.

Examples of photoinitiators according to type (c) typically contain the following moieties for each component: Suitable iodonium salts are described in U.S. Pat. Nos. 3,729,313, 3,741,769, 3,808,006, 4,250,053 and 4,394,403, the iodonium salt disclosures of which are incorporated herein by reference. The iodonium salt can be a simple salt, containing an anion such as Cl⁻, Br⁻, I⁻ or C₄H₅SO₃⁻; or a metal complex salt containing an antimonate, arsenate, phosphate or borate such as SbF₅OH⁻ or AsF₆⁻. Mixtures of iodonium salts can be used if desired. For instance, suitable iodonium salts include each of diphenyliodonium hexafluorophosphate and diphenyliodonium chloride, both commercially available from Sigma-Aldrich (St. Louis, Mo.). The visible light sensitizer may be selected from ketones, coumarin dyes (e.g., ketocoumarins), xanthene dyes, acridine dyes, thiazole dyes, thiazine dyes, oxazine dyes, azine dyes, aminoketone dyes, porphyrins, aromatic polycyclic hydrocarbons, p-substituted aminostyryl ketone compounds, aminotriaryl methanes, merocyanines, squarylium dyes and pyridinium dyes. Preferably, the visible light sensitizer is an alpha-diketone; camphorquinone is particularly preferred and commercially available from Sigma-Aldrich. The electron donor compound is typically an alkyl aromatic polyether or an alkyl, aryl amino compound wherein the aryl group is substituted by one or more electron withdrawing groups. Examples of suitable electron withdrawing groups include carboxylic acid, carboxylic acid ester, ketone, aldehyde, sulfonic acid, sulfonate and nitrile groups. The electron donor compound may be selected from polycylic aromatic compounds (such as biphenylenes, naphthalenes, anthracenes, benzanthracenes, pyrenes, azulenes, pentacenes, decacyclenes, and derivatives (e.g., acenaphthenes) and combinations thereof), and N-alkyl carbazole compounds (e.g., N-methyl carbazole). Preferred donor compounds include 4-dimethylaminobenzoic acid, ethyl 4-dimethylaminobenzoate, 3-dimethylaminobenzoic acid, 4-dimethylaminobenzoin, 4-dimethylaminobenzaldehyde, 4-dimethylaminobenzonitrile and 1,2,4-trimethoxybenzene. Photoinitiators according to type (c) are described in detail, for instance, in co-owned U.S. Pat. No. 6,187,833 (Oxman et al.).

A photoinitiator can be present in a photopolymerizable slurry described herein in any amount according to the particular constraints of the additive manufacturing process. In some embodiments, a photoinitiator is present in a photopolymerizable slurry in an amount of 0.0051 wt. % or more, 0.01 wt. % or more, 0.1 wt. % or more, or 0.3 wt. % or more; and 5% wt. % or less, 4 wt. % or less, 3 wt. % or less, 2 wt. % or less, 1 wt. % or less, or 0.5 wt. % or less, based on the total weight of the photopolymerizable slurry. In some cases, a photoinitiator is present in an amount of about 0.01-5 wt. %, or 0.1-2 wt. %, based on the total weight of the photopolymerizable slurry.

In addition, a photopolymerizable slurry described herein can further comprise one or more sensitizers to increase the effectiveness of one or more photoinitiators that may also be present. In some embodiments, a sensitizer comprises isopropylthioxanthone (ITX) or 2-chlorothioxanthone (CTX). Other sensitizers may also be used. If used in the photopolymerizable composition, a sensitizer can be present in an amount ranging of about 0.01% by weight or about 1% by weight, based on the total weight of the photopolymerizable slurry.

Inhibitor

A photopolymerizable slurry described herein optionally also comprises one or more polymerization inhibitors. A polymerization inhibitor is often included in a photopolymerizable slurry to provide additional thermal stability to the composition. An inhibitor may extend the shelf life of the photopolymerizable slurry, help prevent undesired side reactions, and adjust the polymerization process of the radiation curable component(s) present in the slurry. Adding one or more inhibitor(s) to the photopolymerizable slurry may further help to improving the accuracy or detail resolution of the surface of the ceramic article. Specific examples of inhibitor(s) which can be used include: p-methoxyphenol (MOP), hydroquinone monomethylether (MEHQ), 2,6-di-tert-butyl-4-methyl-phenol (BHT; Ionol), phenothiazine, 2,2,6,6-tetramethyl-piperidine-1-oxyl radical (TEMPO) and mixtures thereof.

In some embodiments, a polymerization inhibitor, if used, is present in an amount of about 0.001-2 wt. %, 0.001 to 5 wt. %, or 0.01-1 wt. %, based on the total weight of the photopolymerizable slurry. Further, if used, a stabilizing agent is present in a photopolymerizable composition described herein in an amount of about 0.1-5 wt. %, about 0.5-4 wt. %, or about 1-3 wt. %, based on the total weight of the photopolymerizable composition.

A photopolymerizable slurry as described herein can also comprise one or more absorption modifiers (e.g., dyes, optical brighteners, pigments, etc.) to control the penetration depth of actinic radiation. One suitable optical brightener is Tinopal OB, a benzoxazole, 2,2′-(2,5-thiophenediyl)bis[5-(1,1-dimethylethyl)], available from BASF Corporation (Florham Park, N.J.). The absorption modifier, if used, can be present in an amount of about 0.001-5 wt. %, about 0.01-1 wt. %, about 0.1-3 wt. %, or about 0.1-1 wt. %, based on the total weight of the photopolymerizable slurry.

### Solvent

In many embodiments, the photopolymerizable slurry according to the present disclosure further comprises at least one (e.g., organic) solvent. Suitable solvents are typically selected to be miscible with water. Further, these solvents are often selected to be soluble in supercritical carbon dioxide or liquid carbon dioxide. The molecular weight of the solvent is usually at least 25 grams/mole (g/mol), at least 30 g/mol, at least 40 g/mol, at least 45 g/mol, at least 50 g/mol, at least g/mol, or at least 100 g/mol. The molecular weight can be up to 300 g/mol, up to 250 g/mol, up to 225 g/mol, up to 200 g/mol, up to 175 g/mol, or up to 150 g/mol. The molecular weight is often in a range of 25 to 300 g/mol, 40 to 300 g/mol, 50 to 200 g/mol, or 75 to 175 g/mol. It is particularly preferable that the one or more solvents have a boiling point above a temperature employed during the additive manufacturing process to minimize solvent evaporation and associated pore formation in a gelled article. For instance, at least one solvent may be used having a boiling point of 150° C. or greater, 160° C. or greater, 170° C. or greater, 180° C. or greater, or 190° C. or greater. In certain embodiments, the amount of one or more solvents in a photopolymerizable slurry is 20 wt. % or more, 25 wt. % or more, 30 wt. % or more, 35 wt. % or more, 40 wt. % or more, or 45 wt. % or more, based on the total weight of the photopolymerizable slurry; and 70 wt. % or less, 65 wt. % or less, 60 wt. % or less, 55 wt. % or less, or 50 wt. % or less, based on the total weight of the photopolymerizable slurry. Stated another way, the photopolymerizable slurry may contain 20 to 70 wt. % solvent, or 20 to 50 wt. % solvent, based on the total weight of the photopolymerizable slurry. Advantageously, in certain embodiments, the presence of solvent can assist in maintaining a pore structure in an article for removing organic material from the article. The solvent medium typically contains less than 15 weight percent water, less than 10 percent water, less than 5 percent water, less than 3 percent water, less than 2 percent water, less than 1 weight percent, or even less than 0.5 weight percent water after a solvent exchange (e.g., distillation) process.

Suitable solvents include for instance and without limitation, diethylene glycol monoethyl ether, ethanol, 1-methoxy-2-propanol (i.e., methoxy propanol), isopropanol, ethylene glycol, N,N-dimethylacetamide, N-methyl pyrrolidone, and combinations thereof. A suitable solvent is often a glycol or polyglycol, mono-ether glycol or mono-ether polyglycol, di-ether glycol or di-ether polyglycol, ether ester glycol or ether ester polyglycol, carbonate, amide, or sulfoxide (e.g., dimethyl sulfoxide). The solvent usually has one or more polar groups. The solvent does not have a polymerizable group; that is, the (e.g., organic) solvent is free of a group that can undergo free radical polymerization. Further, no component of the solvent medium has a polymerizable group that can undergo free radical polymerization.

Suitable glycols or polyglycols, mono-ether glycols or mono-ether polyglycols, di-ether glycols or di-ether polyglycols, and ether ester glycols or ether ester polyglycols are often of Formula (I).

R¹O—(R²O)ₙ—R¹ (I)

In Formula (I), each R¹ independently is hydrogen, alkyl, aryl, or acyl. Suitable alkyl groups often have 1 to 10 carbon atoms, 1 to 6 carbon atoms, or 1 to 4 carbon atoms. Suitable aryl groups often have 6 to 10 carbon atoms and are often phenyl or phenyl substituted with an alkyl group having 1 to 4 carbon atoms. Suitable acyl groups are often of formula —(CO)R³ where R³ is an alkyl having 1 to 10 carbon atoms, 1 to 6 carbon atoms, 1 to 4 carbon atoms, 2 carbon atoms, or 1 carbon atom. The acyl is often an acetate group (—(CO)CH₃). In Formula (I), each R² is typically ethylene or propylene. The variable n is at least 1 and can be in a range of 1 to 10, 1 to 6, 1 to 4, or 1 to 3.

Glycols or polyglycols of Formula (I) have two R′ groups equal to hydrogen. Examples of glycols include, but are not limited to, ethylene glycol, propylene glycol, diethylene glycol, dipropylene glycol, triethylene glycol, and tripropylene glycol.

Mono-ether glycols or mono-ether polyglycols of Formula (I) have a first R′ group equal to hydrogen and a second IV group equal to alkyl or aryl. Examples of mono-ether glycols or mono-ether polyglycols include, but are not limited to, ethylene glycol monohexyl ether, ethylene glycol monophenyl ether, propylene glycol monobutyl ether, diethylene glycol monomethyl ether, diethylene glycol monoethyl ether, diethylene glycol monopropyl ether, diethylene glycol monobutyl ether, diethylene glycol monohexyl ether, dipropylene glycol monomethyl ether, dipropylene glycol monoethyl ether, dipropylene glycol monopropyl ether, triethylene glycol monomethyl ether, triethylene glycol monoethyl ether, triethylene glycol monobutyl ether, tripropylene glycol monomethyl ether, and tripropylene glycol monobutyl ether.

Di-ether glycols or di-ether polyglycols of Formula (I) have two R′ groups equal to alkyl or aryl. Examples of di-ether glycols or di-ether polyglycols include, but are not limited to, ethylene glycol dipropyl ether, ethylene glycol dibutyl ether, dipropylene glycol dibutyl ether, diethylene glycol dimethyl ether, diethylene glycol diethyl ether, triethylene glycol dimethyl ether, tetraethylene glycol dimethyl ether, and pentaethylene glycol dimethyl ether.

Ether ester glycols or ether ester polyglycols of Formula (I) have a first R′ group equal to an alkyl or aryl and a second IV group equal to an acyl. Examples of ether ester glycols or ether ester polyglycols include, but are not limited to, ethylene glycol butyl ether acetate, diethylene glycol butyl ether acetate, and diethylene glycol ethyl ether acetate.

Other suitable solvents are carbonates of Formula (II).

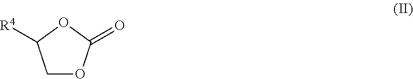

In Formula (II), R⁴ is hydrogen or an alkyl such as an alkyl having 1 to 4 carbon atoms, 1 to 3 carbon atoms, or 1 carbon atom. Examples include ethylene carbonate and propylene carbonate.

Yet other suitable solvents are amides of Formula (III).

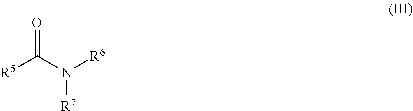

In Formula (III), group R⁵ is hydrogen, alkyl, or combines with R⁶ to form a five-membered ring including the carbonyl attached to R⁵ and the nitrogen atom attached to R⁶. Group R⁶ is hydrogen, alkyl, or combines with R⁵ to form a five-membered ring including the carbonyl attached to R⁵ and the nitrogen atom attached to R⁶. Group R⁷ is hydrogen or alkyl. Suitable alkyl groups for R⁵, R⁶, and R⁷ have 1 to 6 carbon atoms, 1 to 4 carbon atoms, 1 to 3 carbon atoms, or 1 carbon atom. Examples of amide organic solvents of Formula (III) include, but are not limited to, formamide, N,N-dimethylformamide, N,N-dimethylacetamide, N,N-diethylacetamide, N-methyl-2-pyrrolidone, and N-ethyl-2-pyrrolidone.

Additionally, in certain embodiments, the photopolymerizable slurry further comprises a dispersant to assist in distributing the non-oxide ceramic particles in the photopolymerizable slurry. Typically, one or more dispersants can be present in a photopolymerizable slurry in an amount of 0.5 wt. % or greater, based on the total weight of the photopolymerizable slurry, 0.55 wt. % or greater, 0.60 wt. % or greater, 0.65 wt. % or greater, or 0.70 wt. % or greater; and 1.0 wt. % or less, 0.95 wt. % or less, 0.90 wt. % or less, 0.85 wt. % or less, 0.80 wt. % or less, or 0.75 wt. % or less, based on the total weight of the photopolymerizable slurry. Stated another way, the optional dispersant may be present in an amount of 0.5 wt. % to 1.0 wt. %, based on the total weight of the photopolymerizable slurry. Suitable dispersants include for instance and without limitation, dispersants available under the trade designations SOLPLUS or SOLSPERSE from Lubrizol (Wickliffe, Ohio), such as SOLPLUS D510, R700, R720, D540, D545, and D570, SOLSPERSE 20000, S71000, M387, M389, S41000, and S79000, and combinations thereof.

Photopolymerizable compositions materials herein can also exhibit a variety of desirable properties, non-cured, cured, and as post-cured articles. A photopolymerizable slurry (e.g., non-cured) has a viscosity profile consistent with the requirements and parameters of one or more additive manufacturing devices (e.g., 3D printing systems). In certain embodiments, the photopolymerizable slurry exhibits a dynamic viscosity at 23 degrees Celsius of 500 milliPascals seconds (mPa·s) or less, 400 mPa·s or less, 300 mPa·s or less, 200 mPa·s or less, 100 mPa·s or less, 50 mPa·s or less, or 25 mPa·s or less. In some instances, a photopolymerizable slurry described herein when non-cured exhibits a dynamic viscosity of 1 to 500 mPa·s, 1 to 100 mPa·s, or 1 to 50 mPa·s using a Brookfield DV-E Viscometer (Brookfield Engineering Laboratories, Middleboro, Mass.) using disc and cylinder spindles at 23 degrees Celsius and at shear rates of 2 l/s to 20 l/s. In some cases, a photopolymerizable composition described herein when non-cured exhibits a dynamic viscosity of less than about 50 mPa·s.

### Slurries

The preparation of a photopolymerizable slurries is typically conducted under light-restricted conditions to avoid an undesired early polymerization. Often, the photopolymerizable slurry is prepared by speed mixing the components to form a preferably homogenous slurry. The slurry is typically stored in a suitable device like a vessel, a bottle, cartridge or container before use.

### Articles

In a second aspect, the present disclosure provides an aerogel. The aerogel comprises:
a) an organic material;
b) non-oxide ceramic particles in a range of 29 to 75 weight percent, based on the total weight percent of the aerogel; and
c) at least one sintering aid.

In a third aspect, the present disclosure provides a xerogel. The xerogel comprises:
a) an organic material;
b) non-oxide ceramic particles in a range of 29 to 75 weight percent, based on the total weight percent of the xerogel; and
c) at least one sintering aid.

The components of the organic material, non-oxide ceramic particles, and sintering aid of each of the second aspect and the third aspect are as discussed in detail above. When formed using additive manufacturing methods, the aerogel article or xerogel article typically comprises a plurality of layers.

As noted above, an aerogel is a porous material derived from a gel, in which the liquid component of the gel has been replaced with a gas. The solvent removal is often done under supercritical conditions. In contrast, a xerogel is a three-dimensional solid derived from a green body gel, in which the liquid component of the gel has been removed by evaporation under ambient conditions or at an elevated temperature. There is no capillary effect for this type of drying, and the linear shrinkage is often in a range of 0 to 25%, 0 to 20%, 0 to 15%, 5 to 15%, or 0 to 10%. The density typically remains uniform throughout the structure.

The photopolymerizable slurry containing non-oxide ceramic particles is solidified by curing (e.g., gelation). Preferably, the gelation process allows green body gels to be formed of any shape without cracks and green body gels that can be further processed without inducing cracks. For example, preferably, the gelation process leads to a green body gel having a structure that will not collapse when the solvent is removed; so-called “free-standing gel”. It is preferable that the gel contain the minimum amount of organic material or polymer modifiers. After processing the photopolymerizable slurry to form a green body gel, the gelled article is typically removed from the device used for conducting the additive manufacturing process. If desired, the surface of the gelled article is cleaned, e.g., by rinsing with a solvent or soaking in a solvent. Suitable solvents preferably include mixtures thereof or the same solvent(s) used in the slurry described in the present text.

The green body gel structure is compatible with and stable in a variety of solvents and conditions that may be necessary for supercritical extraction. Furthermore, the gel structure should be compatible with supercritical extraction fluids (e.g., supercritical carbon dioxide). In other words, the gels should be stable and strong enough to withstand drying, so as to produce stable aerogels and/or xerogels and give materials that can be heated to burn out the organics, pre-sintered, and densified without inducing cracks. Preferably, the resulting aerogels and/or xerogels have relatively small and uniform pore sizes to aid in sintering them to high density at low sintering temperatures. However, preferably the pores are large enough to allow product gases of organic burnout to escape without leading to cracking of the aerogel or xerogel. It is believed that the rapid nature of the gelation step results in an essentially homogeneous distribution of the non-oxide ceramic particles throughout the gel, which can aid in the subsequent processing steps such as supercritical extraction, organic burnout, and sintering.

If applied, the supercritical drying step can be characterized by at least one, more or all of the following features:
a) Temperature: 20° C. to 100° C., 30° C. to 80° C., or 15° C. to 150° C.;
b) Pressure: 5 to 200 MPa, 10 to 100 MPa, 1 to 20 MPa, or 5 to 15 MPa;
c) Duration: 2 to 175 hours, 5 to 25 hours, or 1 to 5 hours; and
d) Extraction or drying medium: carbon dioxide in its supercritical stage.

A combination of features (a), (b) and (d) is sometimes preferred.

Supercritical extraction can remove all or most of the (e.g., organic) solvent in the printed gel article. In some embodiments, the aerogels contain some residual solvent. The residual solvent can be up to 6 wt. % based on the total weight of the aerogel. For example, the aerogel can contain up to 5 wt. %, up to 4 wt. %, up to 3 wt. %, up to 2 wt. %, or up to 1 wt. % (e.g., organic) solvent. The removal of solvent results in the formation of pores within the dried structure. Preferably, the pores are sufficiently large to allow gases from the decomposition products of the polymeric material to escape without cracking the structure when the dried structure is further heated to burnout the organic material and to form a sintered article.

The article obtained after having conducted the supercritical drying step can typically be characterized by at least one or more of the following properties:
showing a N₂ adsorption and/or desorption isotherm with a hysteresis loop;
showing a N₂ adsorption and desorption of isotherm type IV according to IUPAC classification and a hysteresis loop;
showing a N₂ adsorption and desorption isotherm of type IV with a hysteresis loop of type H1 according to IUPAC classification;
showing a N₂ adsorption and desorption isotherm of type IV with a hysteresis loop of type H1 according to IUPAC classification in a p/p0 range of 0.70 to 0.99;

Heat treating of an aerogel article or xerogel article to form a porous ceramic article may be performed (usually in an atmosphere that includes oxygen) at a temperature of 200 degrees Celsius (° C.) or greater, 300° C. or greater, 400° C. or greater, 500° C. or greater, 600° C. or greater, or 700° C. or greater; and 1200° C. or less, 1100° C. or less, 1000° C. or less, 900° C. or less, or 800° C. or less. Stated another way, heat treating may be performed at a temperature of 200° C. to 1200 degrees Celsius.

In a fourth aspect, a porous ceramic article is provided. The porous ceramic article comprises:
a) non-oxide ceramic particles in a range of 90 to 99 weight percent, based on the total weight of the porous ceramic article; and
b) at least one sintering aid,

wherein the non-oxide ceramic particles define one or more tortuous or arcuate channels, one or more internal architectural voids, one or more undercuts, one or more perforations, or combinations thereof in the porous ceramic article and wherein the porous ceramic article comprises at least one feature integral to the porous ceramic article having a dimension of 0.5 mm length or less.

The components of the non-oxide ceramic particles and sintering aid of the fourth aspect are as discussed in detail above. The shape of the article is not limited, and may comprise a shaped integral article. In many embodiments, the article comprises a shaped integral article, in which more than one variation in dimension is provided by a single integral article. For example, the article can comprise one or more tortuous or arcuate channels, one or more internal architectural voids, one or more undercuts, one or more perforations, or combinations thereof. Such features are typically not possible to provide in an integral article using conventional molding methods. An “internal architectural void” refers to a void fully encompassed within the ceramic article (e.g., does not extend to any exterior surface of the ceramic article) and that has a designed shape, such as programmed into an additive manufacturing device employed to selectively cure the photopolymerizable slurry to create a shape of the ceramic article. An internal architectural void is in contrast to an internal pore formed during manufacture of the ceramic article. In select embodiments, the article comprises a gasket or a washer, having high chemical resistance.

A sintering step is finally carried out to obtain a non-oxide ceramic article having a density of 95% or greater, 96% or greater, 97% or greater, 98% or greater, 99% or greater, 99.5% or greater, or 99.9% or greater, of the theoretical density. Sintering of the porous ceramic article is typically carried out under the flowing conditions:
temperature: from 1700° C. to 2300° C., from 1700° C. to 2000° C., from 2050° C. to 2300° C. or from 1800° C. to 2100° C.; or 1700° C. or greater, 1750° C. or greater, 1800° C. or greater, above 1850° C. or greater, or 1900° C. or greater; and 2300° C. or less, 2250° C. or less, 2200° C. or less, 2150° C. or less, 2100° C. or less, 2050° C. or less, or 2000° C. or less;
atmosphere: inert gas (e.g., nitrogen, argon);
pressure: ambient pressure (e.g., 1013 mbar); and
duration: until a density of 95% to 100% of the final density of the material has been reached.

Alternatively to ambient pressure, the sintering may be carried out at elevated pressure or decreased pressure.

In a fifth aspect, a non-oxide ceramic article is provided. The non-oxide ceramic article comprises: a non-oxide ceramic material defining one or more tortuous or arcuate channels, one or more internal architectural voids, one or more undercuts, one or more perforations, or combinations thereof in the non-oxide ceramic article; wherein the non-oxide ceramic article exhibits a density of 95% or greater with respect to a theoretical density of the non-oxide ceramic material, and wherein the non-oxide ceramic article comprises at least one feature integral to the non-oxide ceramic article having a dimension of 0.5 mm length or less.

The components of the non-oxide ceramic particles of the fifth aspect are as discussed in detail above. Preferably, the non-oxide ceramic particles are selected from the group consisting of silicon carbide, silicon nitride, boron carbide, titanium diboride, zirconium diboride, boron nitride, and combinations thereof.

A relationship of the individual volumes of materials formed in accordance with at least certain embodiments is as follows, for Volume A being scaled to 100:

Volume A (gelled article)=100.

Volume B (postcured gelled article)=90 to 100.

Volume C (xerogel article)=75 to 90

Volume D (aerogel article)=85 to 95

Volume E (white body)=40 to 75

Volume F (fully sintered ceramic article)<45.

Hence, the gelled article has a Volume A, the sintered ceramic article has a Volume F, and wherein Volume F of the sintered ceramic article is less than 45% of Volume A of the gelled article.

Data representing an article (e.g., gelled article) may be generated using computer modeling such as computer aided design (CAD) data. Image data representing the article design can be exported in STL format, or in any other suitable computer processable format, to the additive manufacturing equipment. Scanning methods to scan a three-dimensional object may also be employed to create the data representing the article. One exemplary technique for acquiring the data is digital scanning. Any other suitable scanning technique may be used for scanning an article, including X-ray radiography, laser scanning, computed tomography (CT), magnetic resonance imaging (MRI), and ultrasound imaging. Other possible scanning methods are described, e.g., in U.S. Patent Application Publication No. 2007/0031791 (Cinader, Jr., et al.). The initial digital data set, which may include both raw data from scanning operations and data representing articles derived from the raw data, can be processed to segment an article design from any surrounding structures (e.g., a support for the article).

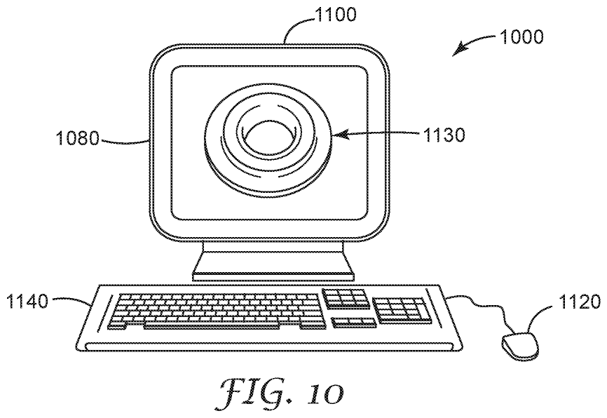

Often, machine-readable media are provided as part of a computing device. The computing device may have one or more processors, volatile memory (RAM), a device for reading machine-readable media, and input/output devices, such as a display, a keyboard, and a pointing device. Further, a computing device may also include other software, firmware, or combinations thereof, such as an operating system and other application software. A computing device may be, for example, a workstation, a laptop, a personal digital assistant (PDA), a server, a mainframe or any other general-purpose or application-specific computing device. A computing device may read executable software instructions from a computer-readable medium (such as a hard drive, a CD-ROM, or a computer memory), or may receive instructions from another source logically connected to computer, such as another networked computer. Referring to FIG. 10, a computing device 1000 often includes an internal processor 1080, a display 1100 (e.g., a monitor), and one or more input devices such as a keyboard 1140 and a mouse 1120. In FIG. 10, a gelled article 1130 is shown on the display 1100.

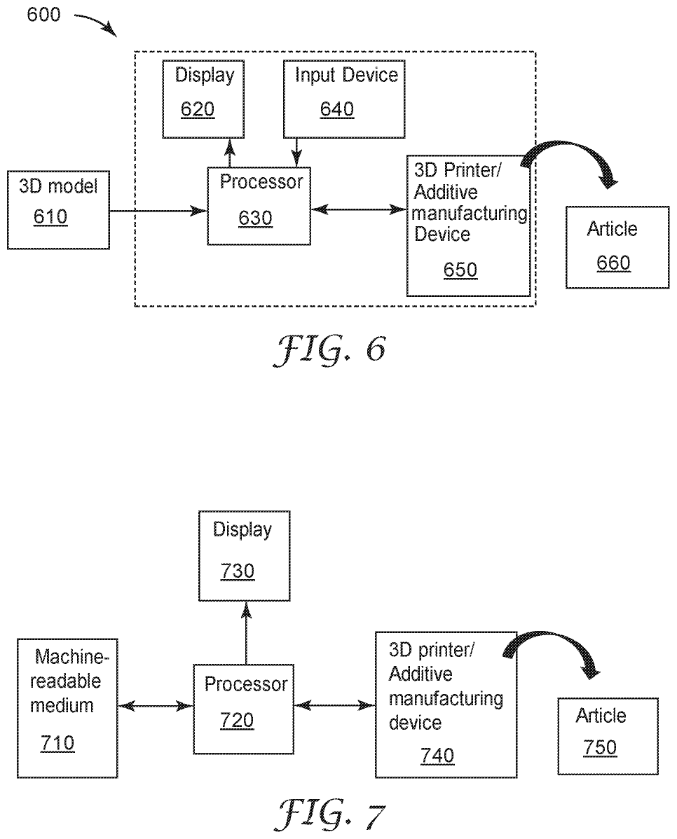

Referring to FIG. 6, in certain embodiments, the present disclosure provides a system 600. The system 600 comprises a display 620 that displays a 3D model 610 of an article (e.g., a gelled article 1130 as shown on the display 1100 of FIG. 10); and one or more processors 630 that, in response to the 3D model 610 selected by a user, cause a 3D printer/additive manufacturing device 650 to create a physical object of the article 660. Often, an input device 640 (e.g., keyboard and/or mouse) is employed with the display 620 and the at least one processor 630, particularly for the user to select the 3D model 610. The article 660 comprises a gelled article obtained by selectively curing a photopolymerizable slurry. The photopolymerizable slurry includes non-oxide ceramic particles; at least one radiation curable monomer; a solvent; a photoinitiator; an inhibitor; and at least one sintering aid. The components of non-oxide ceramic particles, radiation curable monomer, photoinitiator, inhibitor, and sintering aid, are as discussed in detail above.

Referring to FIG. 7, a processor 720 (or more than one processor) is in communication with each of a machine-readable medium 710 (e.g., a non-transitory medium), a 3D printer/additive manufacturing device 740, and optionally a display 730 for viewing by a user. The 3D printer/additive manufacturing device 740 is configured to make one or more articles 750 based on instructions from the processor 720 providing data representing a 3D model of the article 750 (e.g., a gelled article 1130 as shown on the display 1100 of FIG. 10) from the machine-readable medium 710.

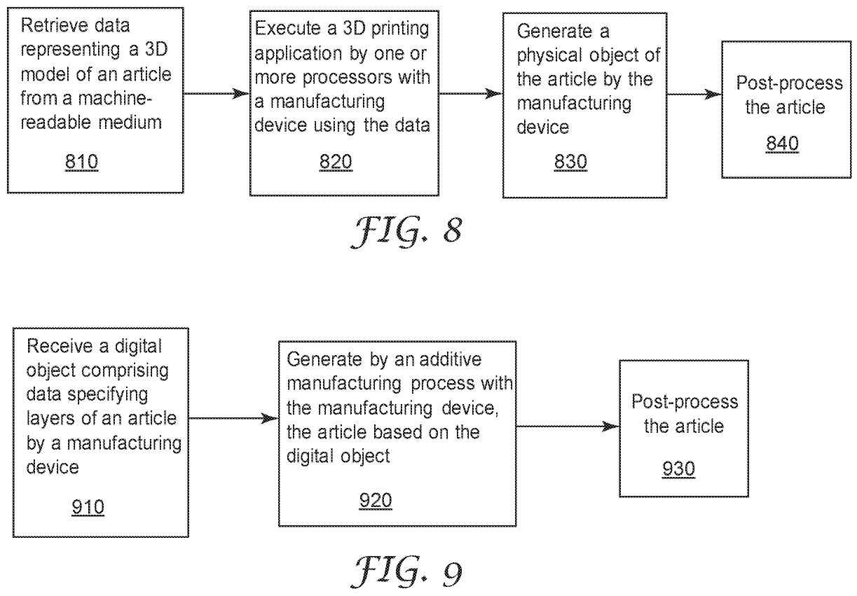

Referring to FIG. 8, for example and without limitation, an additive manufacturing method comprises retrieving 810, from a (e.g., non-transitory) machine-readable medium, data representing a 3D model of an article according to at least one embodiment of the present disclosure. The method further includes executing 820, by one or more processors, an additive manufacturing application interfacing with a manufacturing device using the data; and generating 830, by the manufacturing device, a physical object of the article. The additive manufacturing equipment can selectively cure a photopolymerizable slurry to form a gelled article. The photopolymerizable slurry includes non-oxide ceramic particles; at least one radiation curable monomer; a solvent; a photoinitiator; an inhibitor; and at least one sintering aid. The components of non-oxide ceramic particles, radiation curable monomer, photoinitiator, inhibitor, and sintering aid, are as discussed in detail above. One or more various optional post-processing steps 840 may be undertaken. Typically, the gelled article is dried, heat treated, and sintered to form a ceramic article.

Additionally, referring to FIG. 9, a method of making an article comprises receiving 910, by a manufacturing device having one or more processors, a digital object comprising data specifying a plurality of layers of an article; and generating 920, with the manufacturing device by an additive manufacturing process, the article based on the digital object. Again, the article may undergo one or more steps of post-processing 930.

### Select Embodiments of the Disclosure

Embodiment 1 is a method of making a non-oxide ceramic part. The method includes a) obtaining a photopolymerizable slurry; b) selectively curing the photopolymerizable slurry to obtain a gelled article; c) drying the gelled article to form an aerogel article or a xerogel article; d) heat treating the aerogel article or the xerogel article to form a porous ceramic article; and e) sintering the porous ceramic article to obtain a sintered ceramic article. The photopolymerizable slurry includes non-oxide ceramic particles; at least one radiation curable monomer; a solvent; a photoinitiator; an inhibitor; and at least one sintering aid.

Embodiment 2 is the method of embodiment 1, wherein the drying is performed by applying a supercritical fluid drying step.

Embodiment 3 is the method of embodiment 1 or embodiment 2, wherein the photopolymerizable slurry includes less than 30 percent by weight of the non-oxide ceramic particles, based on the total weight of the photopolymerizable slurry.

Embodiment 4 is the method of any of embodiments 1 to 3, wherein the photopolymerizable slurry contains between 20 percent by weight and up to but not including 30 percent by weight of non-oxide ceramic particles, based on the total weight of the photopolymerizable slurry.

Embodiment 5 is the method of any of embodiments 1 to 4, wherein the gelled article has a Volume A, the sintered ceramic article has a Volume F, and wherein Volume F of the sintered ceramic article is less than 45% of Volume A of the gelled article.

Embodiment 6 is the method of any of embodiments 1 to 5, wherein the non-oxide ceramic particles are selected from the group consisting of silicon carbide, silicon nitride, boron carbide, titanium diboride, zirconium diboride, boron nitride, titanium carbide, zirconium carbide, aluminum nitride, calcium hexaboride, MAX phase, and combinations thereof.

Embodiment 7 is the method of any of embodiments 1 to 6, wherein the non-oxide ceramic particles have an average particle size diameter of 250 nanometers to 10 micrometers, 1 micrometer to 10 micrometers, or 500 nanometers to 1.5 micrometers.

Embodiment 8 is the method of any of embodiments 1 to 7, wherein the photoinitiator comprises a system comprising an iodonium salt, a visible light sensitizer, and an electron donor compound.

Embodiment 9 is the method of embodiment 8, wherein the iodonium salt comprises diphenyliodonium hexafluorophosphate and/or diphenyliodonium chloride, the visible light sensitizer comprises camphorquinone, and the electron donor compound comprises ethyl 4-dimethylaminobenzoate.

Embodiment 10 is the method of any of embodiments 1 to 9, wherein the sintered ceramic article includes at least one feature integral to the sintered ceramic article having a dimension of 0.5 millimeters length or less.

Embodiment 11 is the method of any of embodiments 1 to 10, wherein at least a portion of the non-oxide ceramic particles in the photopolymerizable slurry have a surface modifier attached to a surface of the non-oxide ceramic particles.

Embodiment 12 is the method of any of embodiments 1 to 11, wherein the photopolymerizable slurry includes between 20 and 70 percent by weight of the solvent, based on the total weight of the photopolymerizable slurry.

Embodiment 13 is the method of any of embodiments 1 to 12, wherein the solvent is selected from the group consisting of diethylene glycol monoethyl ether, ethanol, 1-methoxy-2-propanol, N-methyl pyrrolidone, and combinations thereof.

Embodiment 14 is the method of any of embodiments 1 to 13, wherein the photopolymerizable slurry further includes a dispersant.

Embodiment 15 is the method of any of embodiments 1 to 14, wherein the at least one sintering aid includes aluminum oxide, yttrium oxide, zirconium oxide, silicon oxide, titanium oxide, magnesium oxide, calcium oxide, strontium oxide, barium oxide, lithium oxide, sodium oxide, potassium oxide, carbon, boron, boron carbide, aluminum, aluminum nitride, or combinations thereof.

Embodiment 16 is the method of any of embodiments 1 to 15, wherein the photopolymerizable slurry further includes an optical brightener.

Embodiment 17 is the method of any of embodiments 1 to 16, wherein the at least one radiation curable monomer includes an acrylate.

Embodiment 18 is the method of any of embodiments 1 to 17, wherein the photopolymerizable slurry exhibits a viscosity of less than 500 mPa·s at 23 degrees Celsius.

Embodiment 19 is the method of any of embodiments 1 to 18, wherein the selectively curing the photopolymerizable slurry includes curing a portion of the photopolymerizable slurry having a thickness of between 3 micrometers and 50 micrometers.

Embodiment 20 is the method of embodiment 19, wherein the selectively curing the photopolymerizable slurry is repeated at least twice to form the gelled article.

Embodiment 21 is the method of any of embodiments 1 to 20, wherein the heat treating is performed at a temperature of 200 degrees Celsius to 1200 degrees Celsius.

Embodiment 22 is the method of any of embodiments 1 to 21, wherein the sintering the porous ceramic article is performed at ambient pressure.

Embodiment 23 is the method of any of embodiments 1 to 22, wherein the sintering the porous ceramic article is performed at a temperature of 1700 to 2300 degrees Celsius.

Embodiment 24 is the method of any of embodiments 1 to 23, wherein the sintered ceramic article exhibits a density of 95% or greater with respect to a theoretical density of the non-oxide ceramic particles.

Embodiment 25 is the method of any of embodiments 1 to 24, wherein the selectively curing includes employing stereolithographic printing.

Embodiment 26 is an aerogel. The aerogel includes a) an organic material; b) non-oxide ceramic particles in a range of 29 to 75 weight percent, based on the total weight percent of the aerogel; and c) at least one sintering aid.

Embodiment 27 is the aerogel of embodiment 26, wherein the non-oxide ceramic particles are selected from the group consisting of silicon carbide, silicon nitride, boron carbide, titanium diboride, zirconium diboride, boron nitride, titanium carbide, zirconium carbide, aluminum nitride, calcium hexaboride, MAX phase, and combinations thereof.

Embodiment 28 is the aerogel of embodiment 26 or embodiment 27, wherein the non-oxide ceramic particles have an average particle size diameter of 250 nanometers to 10 micrometers.

Embodiment 29 is the aerogel of any of embodiments 26 to 28, wherein the non-oxide ceramic particles have an average particle size diameter of 1 micrometer to 10 micrometers.

Embodiment 30 is the aerogel of any of embodiments 26 to 29, wherein the non-oxide ceramic particles have an average particle size diameter of 500 nanometers to 1.5 micrometers.

Embodiment 31 is the aerogel of any of embodiments 26 to 30, wherein the sintered ceramic article includes at least one feature integral to the aerogel having a dimension of 0.5 millimeters length or less.

Embodiment 32 is the aerogel of any of embodiments 26 to 31, wherein at least a portion of the non-oxide ceramic particles include a surface modifier attached to a surface of the non-oxide ceramic particles.

Embodiment 33 is the aerogel of any of embodiments 26 to 32, wherein the at least one sintering aid includes aluminum oxide, yttrium oxide, zirconium oxide, titanium oxide, magnesium oxide, beryllium oxide, calcium oxide, strontium oxide, barium oxide, lithium oxide, sodium oxide, potassium oxide, rubidium oxide, cesium oxide, carbon, boron, boron carbide, aluminum, or combinations thereof.

Embodiment 34 is a xerogel. The xerogel includes a) an organic material; b) non-oxide ceramic particles in a range of 29 to 75 weight percent, based on the total weight percent of the xerogel; and c). at least one sintering aid.

Embodiment 35 is the xerogel of embodiment 34, wherein the non-oxide ceramic particles are selected from the group consisting of silicon carbide, silicon nitride, boron carbide, titanium diboride, zirconium diboride, boron nitride, and combinations thereof.

Embodiment 36 is the xerogel of embodiment 34 or embodiment 35, wherein the non-oxide ceramic particles have an average particle size diameter of 250 nanometers to 10 micrometers.

Embodiment 37 is the xerogel of any of embodiments 34 to 36, wherein the non-oxide ceramic particles have an average particle size diameter of 1 micrometer to 10 micrometers.

Embodiment 38 is the xerogel of any of embodiments 34 to 37, wherein the non-oxide ceramic particles have an average particle size diameter of 500 nanometers to 1.5 micrometers.

Embodiment 39 is the xerogel of any of embodiments 34 to 38, wherein the sintered ceramic article includes at least one feature integral to the xerogel having a dimension of 0.5 millimeters length or less.

Embodiment 40 is the xerogel of any of embodiments 34 to 39, wherein at least a portion of the non-oxide ceramic particles include a surface modifier attached to a surface of the non-oxide ceramic particles.

Embodiment 41 is the xerogel of any of embodiments 34 to 40, wherein the at least one sintering aid includes aluminum oxide, yttrium oxide, zirconium oxide, silicon oxide, titanium oxide, magnesium oxide, calcium oxide, strontium oxide, barium oxide, lithium oxide, sodium oxide, potassium oxide, carbon, boron, boron carbide, aluminum, aluminum nitride, or combinations thereof.

Embodiment 42 is a porous ceramic article. The porous ceramic article includes a) non-oxide ceramic particles in a range of 90 to 99 weight percent, based on the total weight of the porous ceramic article; and b) at least one sintering aid. The non-oxide ceramic particles define one or more tortuous or arcuate channels, one or more internal architectural voids, one or more undercuts, one or more perforations, or combinations thereof in the porous ceramic article. The porous ceramic article includes at least one feature integral to the porous ceramic article having a dimension of 0.5 mm length or less.

Embodiment 43 is the porous ceramic article of embodiment 42, wherein the non-oxide ceramic particles are selected from the group consisting of silicon carbide, silicon nitride, boron carbide, titanium diboride, zirconium diboride, boron nitride, titanium carbide, zirconium carbide, aluminum nitride, calcium hexaboride, MAX phase, and combinations thereof.

Embodiment 44 is the porous ceramic article of embodiment 42 or embodiment 43, wherein the non-oxide ceramic particles have an average particle size diameter of 250 nanometers to 10 micrometers.

Embodiment 45 is the porous ceramic article of any of embodiments 42 to 44, wherein the non-oxide ceramic particles have an average particle size diameter of 1 micrometer to 10 micrometers.

Embodiment 46 is the porous ceramic article of any of embodiments 42 to 44, wherein the non-oxide ceramic particles have an average particle size diameter of 500 nanometers to 1.5 micrometers.

Embodiment 47 is the porous ceramic article of any of embodiments 42 to 46, wherein the sintered ceramic article includes at least one feature integral to the porous ceramic article having a dimension of 0.5 millimeters length or less.

Embodiment 48 is the porous ceramic article of any of embodiments 42 to 47, wherein at least a portion of the non-oxide ceramic particles include a surface modifier attached to a surface of the non-oxide ceramic particles.

Embodiment 49 is the porous ceramic article of any of embodiments 42 to 48, wherein the at least one sintering aid includes aluminum oxide, yttrium oxide, zirconium oxide, silicon oxide, titanium oxide, magnesium oxide, calcium oxide, strontium oxide, barium oxide, lithium oxide, sodium oxide, potassium oxide, carbon, boron, boron carbide, aluminum, aluminum nitride, or combinations thereof.

Embodiment 50 is a non-oxide ceramic article. The non-oxide ceramic material defines one or more tortuous or arcuate channels, one or more internal architectural voids, one or more undercuts, one or more perforations, or combinations thereof in the non-oxide ceramic article. The non-oxide ceramic article exhibits a density of 95% or greater with respect to a theoretical density of the non-oxide ceramic material. The non-oxide ceramic article includes at least one feature integral to the non-oxide ceramic article having a dimension of 0.5 mm length or less.

Embodiment 51 is the non-oxide ceramic article of embodiment 50, wherein the non-oxide ceramic particles are selected from the group consisting of silicon carbide, silicon nitride, boron carbide, titanium diboride, zirconium diboride, boron nitride, and combinations thereof.

Embodiment 52 is a method. The method includes a) retrieving, from a non-transitory machine readable medium, data representing a 3D model of an article; b) executing, by one or more processors, a 3D printing application interfacing with a manufacturing device using the data; and c) generating, by the manufacturing device, a physical object of the article, the article comprising a gelled article obtained by selectively curing a photopolymerizable slurry. The photopolymerizable slurry includes non-oxide ceramic particles; at least one radiation curable monomer; a solvent; a photoinitiator; an inhibitor; and at least one sintering aid.

Embodiment 53 is a method. The method includes a) receiving, by a manufacturing device having one or more processors, a digital object comprising data specifying a plurality of layers of an article; and b) generating, with the manufacturing device by an additive manufacturing process, the article based on the digital object, the article comprising a gelled article obtained by selectively curing a photopolymerizable slurry. The photopolymerizable slurry includes non-oxide ceramic particles; at least one radiation curable monomer; a solvent; a photoinitiator; an inhibitor; and at least one sintering aid.

Embodiment 54 is an article generated using the method of embodiment 53.

Embodiment 55 is a system. The system includes a display that displays a 3D model of an article; and one or more processors that, in response to the 3D model selected by a user, cause a 3D printer to create a physical object of an article, the article comprising a gelled article obtained by selectively curing a photopolymerizable slurry. The photopolymerizable slurry includes non-oxide ceramic particles; at least one radiation curable monomer; a solvent; a photoinitiator; an inhibitor; and at least one sintering aid.

Embodiment 56 is a non-transitory machine readable medium. The non-transitory machine readable medium includes data representing a three-dimensional model of an article, when accessed by one or more processors interfacing with a 3D printer, causes the 3D printer to create an article comprising a reaction product of a photopolymerizable slurry. The photopolymerizable slurry includes non-oxide ceramic particles; at least one radiation curable monomer; a solvent; a photoinitiator; an inhibitor; and at least one sintering aid.

### EXAMPLES

Objects and advantages of this disclosure are further illustrated by the following examples, but the particular materials and amounts thereof recited in these examples, as well as other conditions and details, should not be construed to unduly limit this disclosure.

Unless otherwise indicated, all parts and percentages are on a weight basis, all water is de-ionized water, and all molecular weights are weight average molecular weight. Moreover, unless otherwise indicated all experiments were conducted at ambient conditions (23° C.; 1013 mbar).

TABLE 1
Materials.

| Material | Source (location) |
|---|---|
| SILZOT Si₃N₄ particles (d50 = 3.6 um, d90 = 5.4 um) | AlzChem Group AG (Trostberg, Germany) |
| SN-E10 Si₃N₄ particles (d50 = 0.75 um, d90 = 1.1 um) | UBE America, Inc. (New York, NY) |
| Y₂O₃ powder | Treibacher Industrie AG (Althofen, Austria) |
| Al₂O₃ powder | Almatis (Ludwigshafen, Germany) |
| BN Cooling Filler Agglomerates | 3M Company (St. Paul, MN) |
| SR351 (trimethylolpropane triacrylate, TMPTA) | Sartomer Americas (Exton, PA) |
| SR399 (dipentaerythritol pentaacrylate) | Sartomer Americas (Exton, PA) |
| SR506A (isobornyl acrylate) | Sartomer Americas (Exton, PA) |
| CARBITOL (diethylene glycol monoethyl ether) | Sigma-Aldrich (St. Louis, MO) |
| OMNIRAD 819 | IGM Resins (Waalwijk, The Netherlands) |
| Camphorquinone | Sigma-Aldrich (St. Louis, MO) |
| Ethyl-4-dimethylamino benzoate (EDMAB) | Sigma-Aldrich (St. Louis, MO) |
| Diphenyliodonium hexafluorophosphate (DPIHFP) | Alfa Aesar (Haverhill, MA) |
| Butylhydroxytoluene (BHT) | Sigma-Aldrich (St. Louis, MO) |
| SR540 - BPA4EO-DMA (BisPhenol A Ethoxylate | Sartomer (Colombes, France) |
| Dimethacrylate) | |
| Visiomer MPMA 98 - HPMA (Monomethacrylate | Evonik (Essen, Germany) |
| Monomer, mixture of Hydroxypropyl | |
| Methacrylates) | |
| CAPA 2043 - CAPA 400 (2-Oxepanone Polymer | Perstorp (Perstorp, Sweden) |
| with 1,4-Butanediol) | |
| SOLVAPERM-ROT PFS (Anthraquinone Dye, | Clariant (Muttenz, Switzerland) |
| C.I. SOLVENT RED 111) | |
| MACROLEX VIOLETT B dye (Anthraquinone | Kremer Pigmente (Aichstetten, Germany) |
| Dye, C.I. SOLVENT VIOLET 13) | |
| PBNII 30200, Nylon 6,6 PA, 68 GSM | Cerex Advanced Fabrics, Inc. (Cantoment, FL) |
| 1280 red tape | 3M Company (St. Paul, MN) |
| SOLSPERSE SOLPLUS R700 | Lubrizol Advanced Materials, Inc. |
| | (Brecksville, OH) |
| Acrylate naphthalimide | Sigma-Aldrich (St. Louis, MO) |

### Methods

1. Printing

To print objects from ceramic slurries, the following procedure was used. A build tray was assembled with a fluoropolymer release film. Approximately 50 mL of a slurry was loaded into the build tray at room temperature. Caution was taken to prevent light exposure by performing procedures in a UV-filtered room (yellow lights), or in low-light conditions when UV-filtering was not available. The build platform was abraded with sand paper and cleaned with IPA as needed. Sometimes a non-woven sheet was attached to provide improved adhesion to the build platform. For some builds, an acrylate base-layer was first cured onto the build platform before starting to cure the slurry. A .stl file was loaded into the software and support structures were applied as required. The settings for printing in the Asiga (Sydney, Australia) Picoplus 27 stereolithography printer are listed in Table 2.

TABLE 2
Standard settings for build using the Asiga Picoplus 27 3D printer.

| Setting | Min | Max | Typical | Units |
|---|---|---|---|---|
| Slice Thickness | 0.001 | 0.05 | 0.01 | mm |
| Separation Distance | 2 | 10 | 4 | mm |
| Separation Velocity | 0.15 | 15 | 2 | mm/s |
| Approach Velocity | 1 | 15 | 2 | mm/s |
| Sliders per layer | 0 | 4 | 1 | |
| Exposure Time | 0.5 | 45 | 2 | s |
| Power | 15 | 30 | 20 | mW/cm² |

After building, the sample was immediately removed from the build platform and rinsed briefly with clean CARBITOL solvent. It was then placed in a sealed container until the next step.

2. Supercritical Extraction

The supercritical extraction step was performed using a 10-L laboratory-scale supercritical fluid extractor unit designed by and obtained from Thar Process, Inc., Pittsburgh, Pa., USA. The SiO₂ based gels were mounted in a stainless steel rack. Sufficient ethanol was added to the 10-L extractor vessel to cover the gels (about 3500-6500 ml). The stainless steel rack containing the wet silica-based gels was loaded into the 10-L extractor so that the wet gels were completely immersed in the liquid ethanol inside the jacketed extractor vessel, which was heated and maintained at 60° C. After the extractor vessel lid was sealed in place, liquid carbon dioxide was pumped by a chilled piston pump (set point: −8.0° C.) through a heat exchanger to heat the CO₂ to 60° C. and into the 10-L extractor vessel until an internal pressure of 13.3 MPa was reached. At these conditions, carbon dioxide is supercritical. Once the extractor operating conditions of 13.3 MPa and 60° C. were met, a needle valve regulated the pressure inside the extractor vessel by opening and closing to allow the extractor effluent to pass through a porous 316L stainless steel frit (obtained from Mott Corporation, New Britain, Conn., USA as Model #1100S-5.480 DIA-062-10-A), then through a heat exchanger to cool the effluent to 30° C., and finally into a 5-L cyclone separator vessel that was maintained at room temperature and pressure less than 5.5 MPa, where the extracted ethanol and gas-phase CO₂ were separated and collected throughout the extraction cycle for recycling and reuse. Supercritical carbon dioxide (scCO₂) was pumped continuously through the 10-L extractor vessel for 8 hours from the time the operating conditions were achieved. After the 8-hour extraction cycle, the extractor vessel was slowly vented into the cyclone separator over 16 hours from 13.3 MPa to atmospheric pressure at 60° C. before the lid was opened and the stainless steel rack containing the dried aerogels was removed. The dry aerogels were removed from their stainless steel rack and placed in labeled bags.

3. Binder Burnout

Binder burn-out was completed in a CM tube furnace (CM Furnaces, Inc., Bloomfield, N.J.) in air. The examples were prepared using the following burn-out profile:
In air, with or without flow, ventilated for fumes
15 hour ramp to 210° C., hold for 30 min
28 hour ramp to 250° C., hold for 30 min
32 hour ramp to 400° C., hold for 30 min
7 hour ramp to 600° C., hold for 1 hour
6 hour ramp to room temperature

4. Sintering

Sintering was completed in an Astro nitrogen-inerted furnace (Thermal Technology, LLC, Santa Rosa, Calif.) by ramping at 75 mV/hour to 305 mV, as measured by a pyrometer, which corresponds 1770° C. to as measured by a separate handheld pyrometer through a viewpoint. The temperature was held at 1770° C. for 3 hours before ramping to room temperature at the cooling rate of the equipment. Some parts were sintered within a loose bed of powder, consisting of 45 wt. % Si₃N₄, 45 wt. % BN, 5 wt. % Al₂O₃, and 5 wt. % Y₂O₃, previously mixed together by rolling in a jar overnight.

5. Cure Depth Analysis

Cure depth of the slurries was analyzed using a photomask of a 4 mm circle and timing the exposure of light on the Asiga Pico 2 3D printer (Asiga USA, Anaheim Hills, Calif.). The cure depth as a function of time for several compositions are shown in Table 3 below.

TABLE 3
Cure depth in micrometers as a function of seconds of cure time.

| | Cure depth (micrometers)\time (s) | | | | | | |
|---|---|---|---|---|---|---|---|
| | 0.5 | 1 | 2 | 4 | 10 | 20 | 30 |
| Silzot Si₃N₄ resin (CE1) | | | 28 | 35 | 42 | 47 | 51 |
| 50 wt. % 531 acrylate + | 30 | 300 | 590 | 770 | 830 | 930 | 910 |
| 50 wt. % CARBITOL | | | | | | | |
| 50 wt. % alumina in 25 | | 90 | 113 | 137 | 173 | 212 | 227 |
| wt. % 531 acrylate + 25 | | | | | | | |
| wt. % CARBITOL | | | | | | | |

### Formulation of (Meth)Acrylate Mixtures

### Preparation of S1 Methacrylate

This methacrylate monomer mixture was prepared by combining 83 wt. % BPA4EO-DMA, 10 wt. % HPMA, 4.67 wt. % CAPA 400, 1.6 wt % OMNIRAD 819, 0.08 wt. % Solvaperm-Rot PFS, and 0.04 wt. % Macrolex Violett B dye with mixing until a homogeneous mixture was obtained.

### Preparation of 531 Acrylate

This acrylate monomer mixture was prepared by combining 51 wt. % SR399, 28.8 wt. % SR351, and 20.2 wt. % SR506A with mixing until a clear, homogeneous mixture was obtained.

Si₃N₄ Powder Mix

The Si₃N₄ powder mix was prepared by combining 90 g of Si₃N₄ powder, either the SILZOT or SN-E10 types, with 5 g of alumina powder and 5 g of yttria powder. In some cases, the mixture was dispersed in ethanol, ball milled overnight, dried in a solvent-rated oven, then ground and sieved with a 150 micrometer opening size. In other cases, the mixture was added directly to the liquid components of the slurry and ball milled overnight as a slurry.

TABLE 4
Resin Compositions

| Example # | CE1 | CE2 | E3 | E4 | CE5 | E6 | E7 | E8 |
|---|---|---|---|---|---|---|---|---|
| Si₃N₄ powder mix (g) | 30 | 30 | 30 | 30 | 20 | 20 | 20 | 30 |
| S1 methacrylate (g) | 45 | 52.5 | — | — | — | — | — | — |
| 531 acrylate (g) | — | — | 25 | 25 | 40 | 25 | 25 | 25 |
| CARBITOL (g) | 25 | 17.5 | 45 | 45 | 40 | 55 | 55 | 45 |
| Solplus dispersant (g) | 1 | 1 | 1 | 1 | 1 | 1 | 1 | 1 |
| OMNIRAD 819 (g) | — | — | 0.5 | 0.5 | 1 | 0.5 | 0.5 | — |
| BHT (g) | — | — | 0.05 | 0.05 | 0.2 | 0.1 | 0.1 | 0.1 |
| Acrylate naphthalimide (g) | — | — | — | 0.025 | — | — | — | — |
| CPQ (g) | — | — | — | — | — | — | — | 0.15 |
| EDMAB (g) | — | — | — | — | — | — | — | 0.55 |
| DPIHFP (g) | — | — | — | — | — | — | — | 0.15 |

### Comparative Example 1 (CE1)

In a polymer jar, the resin ingredients according to Table 4 above were combined with milling media and rolled overnight to fully disperse the powder. The slurry was printed at 10 second exposure per 25 micrometer layer on non-woven spunbond nylon taped onto build platform in an Asiga Picoplus 3D printer (Asiga USA, Anaheim Hills, Calif.) using a vat tray with a fluoropolymer release film and print parameters as above. Solvent was removed using CO₂ supercritical fluid extraction. After SFE, layers of the printed part showed some separation, as shown in FIG. 4A. Burn-out and sintering were completed using the profiles described above. An additional crack formed during burnout, and the part was in shards after sintering, as shown in FIG. 4B.

### Comparative Example 2 (CE2)

In a polymer jar, the resin ingredients according to Table 4 above were combined with milling media and rolled overnight to fully disperse the powder. The slurry was printed at 10 second exposure per 10 micrometer layer onto a methacrylate layer cured onto the build platform in an Asiga Picoplus using a vat tray with a fluoropolymer release film and print parameters as above. Solvent was removed using supercritical fluid extraction, after which some cracking between layers was observed. Burn-out and sintering were completed using the profiles described above. Cracks formed during burnout, and the part was in shards after sintering.

### Example 3 (E3)

In a polymer jar, the resin ingredients according to Table 4 above were combined with milling media and rolled overnight to fully disperse the powder. The slurry was printed at 3 second exposure per 10 micrometer layer on non-woven spunbond nylon taped onto build platform in an Asiga Picoplus using a vat tray with a fluoropolymer release film and print parameters as above, as shown in FIG. 11A. Solvent was removed using supercritical fluid extraction. Burn-out and sintering were completed using the profiles described above. The sintered part was intact with a single broken shard, as shown in FIG. 11B.

### Example 4 (E4)

In a polymer jar, the resin ingredients according to Table 4 above were combined with milling media and rolled overnight to fully disperse the powder. The slurry was printed at 3 second exposure per 10 micrometer layer on non-woven spunbond nylon taped onto build platform in an Asiga Picoplus using a vat tray with a fluoropolymer release film and print parameters as above. Solvent was removed using supercritical fluid extraction. Burn-out and sintering were completed using the profiles described above. The sintered part was intact. Archimedes density was measured as 3.230 g/cm³.

### Comparative Example 5 (CE5)

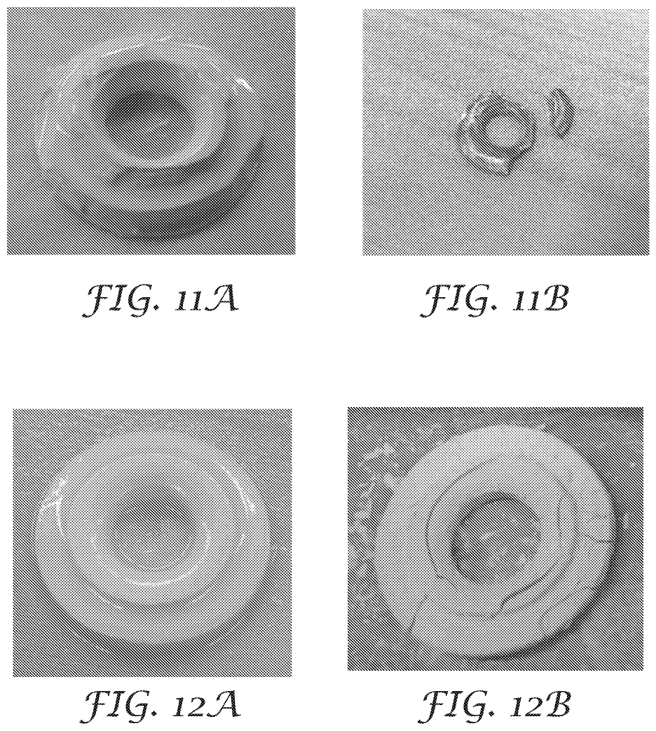

In a polymer jar, the resin ingredients according to Table 4 above were combined with milling media and rolled overnight to fully disperse the powder. The slurry was printed at 1 second exposure per 10 micrometer layer on non-woven spunbond nylon taped onto build platform in an Asiga Picoplus using a vat tray with a fluoropolymer release film and print parameters as above. The part as printed is shown in FIG. 12A. Solvent was removed using supercritical fluid extraction, after which extensive cracking was observed, as shown in FIG. 12B. The part was not continued through with subsequent post-processing.

### Example 6 (E6)

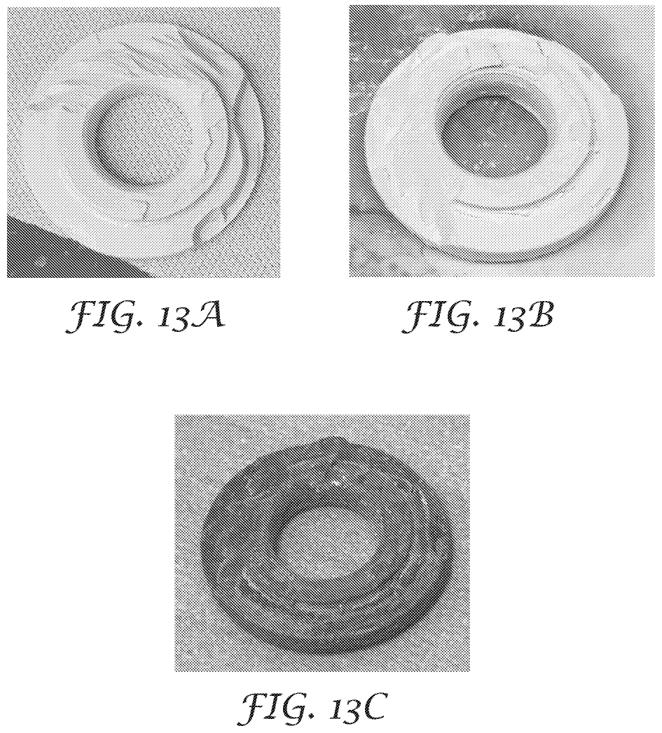

In a polymer jar, the resin ingredients according to Table 4 above were combined with milling media and rolled overnight to fully disperse the powder. The slurry was printed at 1 second exposure per 10 micrometer layer on non-woven spunbond nylon taped onto build platform in an Asiga Picoplus 3D printer using a vat tray with a fluoropolymer release film and print parameters as above. The part as printed is shown in FIG. 13A. Solvent was removed using supercritical fluid extraction successfully, as shown in FIG. 13B. Burnout and sintering were completed successfully as well using the profiles described above, resulting in a solid final part, as shown in FIG. 13C. Archimedes density was measured as 3.232 g/cm³.

### Example 7 (E7)

In a polymer jar, the resin ingredients according to Table 4 above were combined with milling media and rolled overnight to fully disperse the powder. The slurry was printed at 2 second exposure per 10 micrometer layer on non-woven spunbond nylon taped onto build platform in an Asiga Picoplus 3D printer using a vat tray with a fluoropolymer release film and print parameters as above. Solvent was removed using supercritical fluid extraction successfully. Burnout and sintering were completed successfully as well using the profiles described above, resulting in a solid final part. Archimedes density was measured as 3.221 g/cm³.

### Example 8 (E8)

In a polymer jar, the resin ingredients according to Table 4 above were combined with milling media and rolled overnight to fully disperse the powder. The slurry was printed at 10 second exposure per 10 micrometer layer on non-woven spunbond nylon taped onto build platform in an Asiga Picoplus 3D printer, modified to use a 460 nm LED, using a vat tray with a fluoropolymer release film and print parameters as above. Solvent was removed using supercritical fluid extraction successfully. Burnout and sintering were completed successfully as well using the profiles described above, resulting in a solid final part.

All of the patents and patent applications mentioned above are hereby expressly incorporated by reference. The embodiments described above are illustrative of the present invention and other constructions are also possible. Accordingly, the present invention should not be deemed limited to the embodiments described in detail above and shown in the accompanying drawings, but instead only by a fair scope of the claims that follow along with their equivalents.

1. A method of making a non-oxide ceramic part, the method comprising:
a) obtaining a photopolymerizable slurry, the photopolymerizable slurry comprising a plurality of non-oxide ceramic particles; at least one radiation curable monomer;
a solvent; a photoinitiator; an inhibitor; and at least one sintering aid;
b) selectively curing the photopolymerizable slurry to obtain a gelled article;
c) drying the gelled article to form an aerogel article or a xerogel article;
d) heat treating the aerogel article or the xerogel article to form a porous ceramic article; and
e) sintering the porous ceramic article to obtain a sintered ceramic article.

2. The method of claim 1, wherein the drying is performed by applying a supercritical fluid drying step.

3. The method of claim 1, wherein the photopolymerizable slurry comprises less than 30 percent by weight of the non-oxide ceramic particles, based on the total weight of the photopolymerizable slurry.

4. The method of claim 1, wherein the photopolymerizable slurry comprises between 20 percent by weight and up to but not including 30 percent by weight of non-oxide ceramic particles, based on the total weight of the photopolymerizable slurry.

5. The method of claim 1, wherein the gelled article has a Volume A, the sintered ceramic article has a Volume F, and wherein Volume F of the sintered ceramic article is less than 45% of Volume A of the gelled article.

6. The method of claim 1, wherein the non-oxide ceramic particles are selected from the group consisting of silicon carbide, silicon nitride, boron carbide, titanium diboride, zirconium diboride, boron nitride, titanium carbide, zirconium carbide, aluminum nitride, calcium hexaboride, MAX phase, and combinations thereof.

7. The method of claim 1, wherein the non-oxide ceramic particles comprise an average particle size diameter of 250 nanometers to 1 micrometer, 500 nanometers to 1.5 micrometers, or 1 micrometer to 10 micrometers.

8. The method of claim 1, wherein the photoinitiator comprises a system comprising an iodonium salt, a visible light sensitizer, and an electron donor compound.

9. The method of claim 1, wherein the photopolymerizable slurry further comprises a dispersant.

10. The method of claim 1, wherein the at least one sintering aid comprises aluminum oxide, yttrium oxide, zirconium oxide, silicon oxide, titanium oxide, magnesium oxide, calcium oxide, strontium oxide, barium oxide, lithium oxide, sodium oxide, potassium oxide, carbon, boron, boron carbide, aluminum, aluminum nitride, or combinations thereof.

11. The method of claim 1, wherein the selectively curing the photopolymerizable slurry comprises curing a portion of the photopolymerizable slurry having a thickness of between 3 micrometers and 50 micrometers.

12. The method of claim 11, wherein the selectively curing the photopolymerizable slurry is repeated at least twice to form the gelled article.

13. The method of claim 1, wherein the sintered ceramic article exhibits a density of 95% or greater with respect to a theoretical density of the non-oxide ceramic particles.

14. The method of claim 1, further comprising milling the plurality of non-oxide ceramic particles into the solvent.

15. An aerogel comprising:
a) an organic material;
b) non-oxide ceramic particles in a range of 29 to 75 weight percent, based on the total weight percent of the aerogel; and
c) at least one sintering aid.

16. A xerogel comprising:
a) an organic material;
b) non-oxide ceramic particles in a range of 29 to 75 weight percent, based on the total weight percent of the xerogel; and
c) at least one sintering aid.

17. A porous ceramic article comprising:
a) non-oxide ceramic particles in a range of 90 to 99 weight percent, based on the total weight of the porous ceramic article; and
b) at least one sintering aid,
wherein the non-oxide ceramic particles define one or more tortuous or arcuate channels, one or more internal architectural voids, one or more undercuts, one or more perforations, or combinations thereof in the porous ceramic article and wherein the porous ceramic article comprises at least one feature integral to the porous ceramic article having a dimension of 0.5 mm length or less.

18. A non-oxide ceramic article comprising:
a non-oxide ceramic material defining one or more tortuous or arcuate channels, one or more internal architectural voids, one or more undercuts, one or more perforations, or combinations thereof in the non-oxide ceramic article; wherein the non-oxide ceramic article exhibits a density of 95% or greater with respect to a theoretical density of the non-oxide ceramic material, and wherein the non-oxide ceramic article comprises at least one feature integral to the non-oxide ceramic article having a dimension of 0.5 mm length or less.

19. (canceled)

20. A method comprising:
a) receiving, by a manufacturing device having one or more processors, a digital object comprising data specifying a plurality of layers of an article; and
b) generating, with the manufacturing device by an additive manufacturing process, the article based on the digital object, the article comprising a gelled article obtained by selectively curing a photopolymerizable slurry, the photopolymerizable slurry comprising:
1) a plurality of non-oxide ceramic particles;
2) at least one radiation curable monomer;
3) a solvent;
4) a photoinitiator;
5) an inhibitor; and
6) at least one sintering aid.

21. (canceled)

22. (canceled)
